(19) United States
(12) Patent Application Publication
(10) Pub. No.: US 2023/0155778 A1
(43) Pub. Date: May 18, 2023

(54) MAC CE for SRS For Positioning

(71) Applicant: Telefonaktiebolaget LM Ericsson (publ), Stockholm (SE)

(72) Inventors: Ritesh Shreevastav, Upplands Väsby (SE); Florent Munier, Västra Frölunda (SE); Helka-Liina Määttänen, Helsinki (FI)

(21) Appl. No.: 17/919,548

(22) PCT Filed: Feb. 25, 2021
(86) PCT No.: PCT/SE2021/050159

§ 371 Date: Oct. 18, 2022

Related U.S. Application Data
(60) Provisional application No. 63/012,350, filed on Apr. 20, 2020.

(51) Int. Cl. H04L 5/00

(52) U.S. Cl. CPC H04L 5/0051; H04L 5/0094

(57) ABSTRACT

Embodiments described herein relate to methods and apparatuses for providing a Medium Access Control, MAC, Control Element, CE. A method performed by a wireless device comprises receiving a Medium Access Control, MAC, Control Element, CE, wherein the MAC CE comprises information indicating whether a Sounding Reference Signal, SRS, for spatial relation is available.

### TECHNICAL FIELD

Embodiments described herein relate to methods and apparatuses for providing a Medium Access Control, MAC, Control Element, CE.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Embodiments described herein relate to an efficient Medium Access Control (MAC) Control Element (CE) Design for Sounding Reference Signal (SRS) for positioning.

NR Positioning

Positioning has been a topic in LTE standardization since 3GPP Release 9. The primary objective is to fulfil regulatory requirements for emergency call positioning. Positioning in New Radio, NR, that is, the 5^{th} generation (5G) radio network, is proposed to be supported by the architecture shown in FIG. 1. The Location Management Function, LMF, is the location node in NR. There are also interactions between the location node and the gNodeB via the NRPPa protocol. The interactions between the gNodeB and the device is supported via the Radio Resource Control (RRC) protocol.

FIG. 1 illustrates NG-RAN Rel-15 LCS Protocols

It will be appreciated that the gNB and ng-eNB may not always both be present.

It will also be appreciated that when both the gNB and ng-eNB are present, the NG-C interface is only present for one of them.

In the legacy LTE standards, the following techniques are supported:
Enhanced Cell ID. Essentially cell ID information to associate the device to the serving area of a serving cell, and then additional information to determine a finer granularity position.
Assisted GNSS. GNSS information retrieved by the device, supported by assistance information provided to the device from E-SMLC
OTDOA (Observed Time Difference of Arrival). The device estimates the time difference of reference signals from different base stations and sends to the E-SMLC for multi-lateration.
UTDOA (Uplink TDOA). The device is requested to transmit a specific waveform that is detected by multiple location measurement units (e.g. an eNB) at known positions. These measurements are forwarded to E-SMLC for multilateration

The NR positioning for Rel. 16, based on the 3GPP NR radio-technology, is uniquely positioned to provide added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based on OTDOA and UTDOA, Cell-ID or E-Cell-ID etc., utilizing timing measurements to locate a UE. The recent advances in massive antenna systems (massive MIMO) can provide additional degrees of freedom to enable a more accurate user location estimation by exploiting spatial and angular domains of the propagation channel in combination with time measurements.

With 3GPP Release 9 Positioning Reference Signals (PRS) have been introduced for antenna port 6 as the Release 8 cell-specific reference signals are not sufficient for positioning. The simple reason is that the required high probability of detection could not be guaranteed. A neighbor cell with its synchronization signals (Primary-/Secondary Synchronization Signals) and reference signals is seen as detectable, when the Signal-to-Interference-and-Noise Ratio (SINR) is at least −6 dB. Simulations during standardization have however shown, that this can be only guaranteed for 70% of all cases for the 3rd best-detected cell, i.e. the 2nd best neighboring cell. This is not enough and it has been assumed an interference-free environment, which cannot be ensured in a real-world scenario. However, PRS have still some similarities with cell-specific reference signals as defined in 3GPP Release 8. It is a pseudo-random QPSK sequence that is being mapped in diagonal patterns with shifts in frequency and time to avoid collision with cell-specific reference signals and an overlap with the control channels (PDCCH).

NR Rel. 16 is expected to include a NR Downlink Positioning Reference Signal (DL PRS) based on a staggered comb resource element pattern as well as extension of Rel-15 SRS configurations for improved positioning support. Support for RSTD measurements that may be used for OTDOA is expected as well as multi cell UE RX-TX time difference measurements that can be used for Round Trip Time (RTT) estimation. Rich reporting of multiple CIR/correlation peaks has been discussed as well as reporting of the strongest CIR/correlation peak.

NR Rel. 16 will also support beamforming. The DL PRS is constructed as a DL PRS Resource set consisting of multiple DL PRS Resources. Each DL PRS Resource is transmitted over a separate beam. An UL SRS may have a spatial relation to a DL PRS Resource as signaled through the combination of a DL PRS Resource set ID and a DL PRS Resource ID. The UE will then transmit the UL SRS using the same antenna panel as it uses to receive the corresponding DL PRS resource and using the same (reciprocal) beam as it uses to receive the DL PRS Resource.

Beamforming

The use of multi-antenna schemes in NR is a key concept. For NR, frequency ranges up to 100 GHz are considered. Currently, two NR frequency ranges are explicitly distinguished in 3GPP: frequency range FR1 (below 6 GHz) and frequency range FR2 (above 6 GHz). It is known that high-frequency radio communication above 6 GHz suffers from significant path loss and penetration loss. One solution to address this issue is to deploy large-scale antenna arrays to achieve high beamforming gain, which is a reasonable solution due to the small wavelength of high-frequency signal. Therefore, MIMO schemes for NR are also called massive MIMO. Up to 64 beams are now supported for FR2. For sub-6 GHz communication, to obtain more beamforming and multiplexing gain by increasing the number of antenna elements is also a trend.

With massive MIMO, three approaches to beamforming have been discussed: analog, digital, and hybrid (a combination of the two). The analog beamforming would compensate high pathloss in NR scenarios, while digital precoding would provide additional performance gains similar to MIMO for sub-6 GHz necessary to achieve a reasonable coverage. The implementation complexity of analog beamforming is significantly less than digital precoding since it is in many implementations relies on simple phase shifters, but the drawbacks are its limitation in multi-direction flexibility (i.e., a single beam can be formed at a time and the beams are then switched in time domain), only wideband transmissions (i.e., not possible to transmit over a subband), unavoidable inaccuracies in the analog domain, etc. Digital beamforming (requiring costly converters to/from the digital domain from/to IF domain), used today in LTE, provides the best performance in terms of data rate and multiplexing capabilities (multiple beams over multiple subbands at a time can be formed), but at the same time it is challenging in terms of power consumption, integration, and cost; in addition to that the gains do not scale linearly with the number of transmit/receive units while the cost is growing rapidly. Supporting hybrid beamforming, to benefit from cost-efficient analog beamforming and high-capacity digital beamforming, is therefore desirable for NR. An example diagram for hybrid beamforming is shown in FIG. 2.

Beamforming can be on transmission beams and/or reception beams, network side or UE side.

Beamforming can be at the tx side and/or rx side; the basic principles are similar for tx and rx beamforming, except that the signal is not transmitted in the end via beams but being received with rx beamforming instead.

Beam Sweeping

The analog beam of a subarray can be steered toward a single direction on each OFDM symbol, and hence the number of subarrays determines the number of beam directions and the corresponding coverage on each OFDM symbol. However, the number of beams to cover the whole serving area is typically larger than the number of subarrays, especially when the individual beam-width is narrow. Therefore, to cover the whole serving area, multiple transmissions with narrow beams differently steered in time domain are also likely to be needed. The provision of multiple narrow coverage beams for this purpose has been called “beam sweeping”. For analog and hybrid beamforming, the beam sweeping seems to be essential to provide the basic coverage in NR. For this purpose, multiple OFDM symbols, in which differently steered beams can be transmitted through subarrays, can be assigned and periodically transmitted.

The Rx beam sweeping is similar to Tx beam sweeping but at the receiver side, sweeping over Rx beams instead.

FIG. 3a illustrates beam sweeping on 2 subarrays

FIG. 3b illustrates beam sweeping on 3 subarrays.

MAC Specification

The Current agreement is as below on MAC CE design for positioning

MAC Control Elements (CEs)

SP Positioning Sounding Reference Signal (SRS) Activation/Deactivation MAC CE

The SP Positioning SRS Activation/Deactivation MAC CE is identified by a MAC subheader with Logical Channel Identifier (LCID) and Extended LCID (eLCID) as specified in Table 6.2.1-x. It has a variable size with following fields:
A/D: This field indicates whether to activate or deactivate indicated SP Positioning SRS resource set. The field is set to 1 to indicate activation, otherwise it indicates deactivation;
Positioning SRS Resource Set's Cell ID: This field indicates the identity of the Serving Cell, which contains activated/deactivated SP Positioning SRS Resource Set. If the C field is set to 0, this field also indicates the identity of the Serving Cell which contains all resources indicated by the Spatial Relation for Resource IDᵢ fields, if present. The length of the field is 5 bits;
Positioning SRS Resource Set's BWP ID: This field indicates a UL BWP as the codepoint of the DCI bandwidth part indicator field as specified in TS 38.212, which contains activated/deactivated SP Positioning SRS Resource Set. If the C field is set to 0, this field also indicates the identity of the BWP which contains all resources indicated by the Spatial Relation for Resource IDᵢ fields, if present. The length of the field is 2 bits;
C: This field indicates whether the octets containing Resource Serving Cell ID field(s) and Resource BWP ID field(s) within the field Spatial Relation for Resource IDᵢ are present, except for Spatial Relation Resource IDᵢ with Downlink Positioning Reference Signal (DL-PRS) or Synchronization Signal Block (SSB). When A/D is set to 1, if this field is set to 1, the octets containing Resource Serving Cell ID field(s) and Resource BWP ID field(s) in the field Spatial Relation for Resource IDᵢ are present, otherwise they are not present. When A/D is set to 0, this field is always set to 0 that they are not present;
SUL: This field indicates whether the MAC CE applies to the Normal Uplink (NUL) carrier or Supplementary Uplink (SUL) carrier configuration. This field is set to 1 to indicate that it applies to the SUL carrier configuration, and it is set to 0 to indicate that it applies to the NUL carrier configuration;
Positioning SRS Resource Set ID: This field indicates the SP Positioning SRS Resource Set identified by SRS-PosResourceSetId as specified in TS 38.331, which is to be activated or deactivated. The length of the field is 4 bits;
Spatial Relation for Resource IDᵢ: The field Spatial Relation for Resource IDᵢ is only present if MAC CE is used for activation, i.e. the ND field is set to 1. M is the total number of Positioning SRS resource(s) configured under the SP Positioning SRS resource set indicated by the field Positioning SRS Resource Set ID. There are 4 types of Spatial Relation for Resource IDᵢ, which is indicated by the F (F₀ and Fₑ) field within. The fields within Spatial Relation for Resource IDᵢ are shown in FIG. 5 to FIG. 8 below for the 4 types of Spatial Relations for Resource IDᵢ;
R: Reserved bit, set to 0.

FIG. 4 illustrates SP Positioning SRS Activation/Deactivation MAC CE

FIG. 5 illustrates a Spatial Relation for Resource IDi with NZP CSI-RS

FIG. 6 illustrates a Spatial Relation for Resource IDi with SSB

FIG. 7 illustrates a Spatial Relation for Resource IDi with SRS

FIG. 8 illustrates a Spatial Relation for Resource IDi with DL-PRS

The field Spatial Relation for Resource IDᵢ consists of the following fields:
F₀: This field indicates the type of a resource used as a spatial relation for the i^{th} Positioning SRS resource within the Positioning SRS Resource Set indicated with the field Positioning SRS Resource Set ID. The field is set to 00 to indicate NZP CSI-RS resource index is used; it is set to 01 to indicate SSB index is used; it is set to 10 to indicate SRS resource index is used; it is set to 11 to indicate DL-PRS index is used. The length of the field is 2 bits;
F₁: This field indicates the type of SRS resource used as spatial relation for the i^{th} Positioning SRS resource within the SP Positioning SRS Resource Set indicated with the field Positioning SRS Resource Set ID when F₀ is set to 10. The field is set to 0 to indicate SRS resource index SRS-ResourceId as defined in TS 38.331 is used; the field is set to 1 to indicate Positioning SRS resource index SRS-PosResourceId as defined in TS 38.331 is used;
NZP CSI-RS Resource ID: This field contains an index of NZP-CSI-RS-ResourceID, as specified in TS 38.331, indicating the NZP CSI-RS resource, which is used to derive the spatial relation for the positioning SRS. The length of the field is 8 bits;
SSB index: This field contains an index of SSB SSB-Index as specified in TS 38.331 and/or TS 37.355. The length of the field is 6 bits;
PCI: This field contains physical cell identity PhysCellId as specified in TS 38.331 and/or TS 37.355. The length of the field is 10 bits;
SRS resource ID: When F₁ is set to 0, the field indicates an index for SRS resource SRS-ResourceId as defined in TS 38.331; When F₁ is set to 1, the field indicates an index for Positioning SRS resource SRS-PosResourceId as defined in TS 38.331. The length of the field is 5 bits;
DL-PRS Resource Set ID: This field contains an index for DL-PRS Resource Set nr-DL-PRS-ResourceSetId as defined in TS 37.355. The length of the field is 3 bits;
DL-PRS Resource ID: This field contains an index for DL-PRS resource nr-DL-PRS-ResourceId as defined in TS 37.355. The length of the field is 6 bits;
DL-PRS ID: This field contains an identity for DL-PRS resource dl-PRS-ID as defined in TS 37.355. The length of the field is 8 bits;
Resource Serving Cell IDᵢ: This field indicates the identity of the Serving Cell on which the resource used for spatial relationship derivation for the i^{th} Positioning SRS resource is located. The length of the field is 5 bits;
Resource BWP IDᵢ: This field indicates a UL BWP as the codepoint of the DCI bandwidth part indicator field as specified in TS 38.212, on which the resource used for spatial relationship derivation for the i^{th} Positioning SRS resource is located. The length of the field is 2 bits.

There currently exist certain challenge(s).

In FR2 which works in mmWave length at high frequency, it is needed to define Spatial relations (DL and UL Beam alignment). It will minimize interference and UE's SRS will be easily heard by neighbor gNBs/TRPs.

As shown in previous table; MAC CE SRS for positioning needs several octets to define the spatial relations. Larger MAC CE will take longer processing in UE and for some critical positioning application where latency is important, a possible lean MAC CE design should be considered.

In FR1; which works in low or mid frequency band, the UL SRS directed towards serving cell is adequate also for the neighbor cell/TRPs to listen and perform the required Relative Time of arrival (RTOA) measurements.

Further, the current design provides spatial relation for each bandwidth part. If a UE supports multiple BWP; then the spatial relation may need to be provided for all BWP.

In some cases, it can also be optional to provide a full spatial relation configuration; for example, considering DL-PRS; the current design considers TRP ID, Resource set ID and Resource ID. However, it is possible to convey only TRP ID and Resource set ID. UE can identify the suitable resource ID from the provided TRP ID and Resource set ID.

Further, for semi-persistent Supplementary Uplink (SUL) may also be configured as indicated by SUL field in the MAC CE. However, for MAC entity to use this SUL, it should be known to LMF and other listening nodes (gNB, TRPs) that UL transmission is not in normal UL but in SUL.

Certain aspects of the present disclosure and their embodiments may provide solutions to these or other challenges.

### SUMMARY

There are, proposed herein, various embodiments which address one or more of the issues disclosed herein.

Generally, embodiments disclosed herein make the MAC CE design as lean as possible.

According to some embodiments there is provided a method performed by a wireless device. The method comprise receiving a Medium Access Control, MAC, Control Element, CE, wherein the MAC CE comprises information indicating whether a Sounding Reference Signal, SRS, for spatial relation is available.

According to some embodiments there is provided a method performed by a wireless device. The method comprises receiving a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.

According to some embodiments there is provided a method performed by a base station for configuring a wireless device. The method comprises transmitting a Medium Access Control, MAC, Control Element, CE, wherein the MAC CE comprises information indicating whether a Sounding Reference Signal, SRS, for spatial relation is available.

According to some embodiments there is provided a method performed by a base station for configuring a wireless device. The method comprises transmitting a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.

According to some embodiments there is provided a wireless device comprising processing circuitry. The processing circuitry is configured to cause the wireless device to receive a Medium Access Control, MAC, Control Element, CE, wherein the MAC CE comprises information indicating whether a Sounding Reference Signal, SRS, for spatial relation is available.

According to some embodiments there is provided a wireless device comprising processing circuitry. The processing circuitry is configured to cause the wireless device to receive a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.

According to some embodiments there is provided a base station comprising processing circuitry. The processing circuitry is configured to cause the base station to transmit a Medium Access Control, MAC, Control Element, CE, wherein the MAC CE comprises information indicating whether a Sounding Reference Signal, SRS, for spatial relation is available.

According to some embodiments there is provided a base station comprising processing circuitry. The processing circuitry is configured to cause the base station to transmit a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.

For example, the field that determines if spatial relation is present or not, the size of the MAC CE network needs to send to the UE can be reduced considerably.

As another example, the field that indicates that the MAC CE applies to all BWPs configured for the UE is applied, network needs to send only one MAC CE per serving cell.

As another example, if another field is used, only one MAC CE per UE needs to be sent.

These fields can be used together or separately in the MAC CE design.

Thus, certain embodiments may provide one or more of the following technical advantage(s).

Specifically, it is possible to configure the MAC CE design as lean as possible. This means essentially that, by applying the field that determines if spatial relation is present or not, the size of the MAC CE that the network needs to send to the UE can be reduced considerably. Further, if the field that indicates that the MAC CE applies to all BWPs configured for the UE is applied, the network needs to send only one MAC CE per serving cell. Or, if another field is used, only one MAC CE per UE needs to be sent.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates NG-RAN Rel-15 LCS Protocols;

FIG. 2 illustrates hybrid beamforming;

FIG. 3a illustrates beam sweeping on 2 subarrays;

FIG. 3b illustrates beam sweeping on 3 subarrays;

FIG. 4 illustrates SP Positioning SRS Activation/Deactivation MAC CE;

FIG. 5 illustrates a Spatial Relation for Resource IDi with NZP CSI-RS

FIG. 6 illustrates a Spatial Relation for Resource IDi with SSB;

FIG. 7 illustrates a Spatial Relation for Resource IDi with SRS;

FIG. 8 illustrates a Spatial Relation for Resource IDi with DL-PRS;

FIG. 9 illustrates SP Positioning SRS Activation/Deactivation MAC CE;

FIG. 10 illustrates SP Positioning SRS Activation/Deactivation MAC CE;

FIG. 11 illustrates Spatial Relation for Resource IDi with DL-PRS;

FIG. 12 illustrates a wireless network in accordance with some embodiments;

FIG. 13 illustrates a User Equipment in accordance with some embodiments;

FIG. 14 illustrates a Virtualization environment in accordance with some embodiments;

FIG. 15 illustrates a Telecommunication network connected via an intermediate network to a host computer in accordance with some embodiments;

FIG. 16 illustrates a Host computer communicating via a base station with a user equipment over a partially wireless connection in accordance with some embodiments;

FIG. 17 illustrates methods implemented in a communication system including a host computer, a base station and a user equipment in accordance with some embodiments;

FIG. 18 illustrates methods implemented in a communication system including a host computer, a base station and a user equipment in accordance with some embodiments;

FIG. 19 illustrates methods implemented in a communication system including a host computer, a base station and a user equipment in accordance with some embodiments;

FIG. 20 illustrates methods implemented in a communication system including a host computer, a base station and a user equipment in accordance with some embodiments;

FIG. 21 illustrates a method in accordance with some embodiments;

FIG. 22 illustrates a virtualization apparatus in accordance with some embodiments;

FIG. 23 illustrates a method in accordance with some embodiments;

FIG. 24 illustrates a virtualization apparatus in accordance with some embodiments;

FIG. 25 illustrates a method in accordance with some embodiments;

FIG. 26 illustrates a virtualization apparatus in accordance with some embodiments;

FIG. 27 illustrates a method in accordance with some embodiments;

FIG. 28 illustrates a virtualization apparatus in accordance with some embodiments.

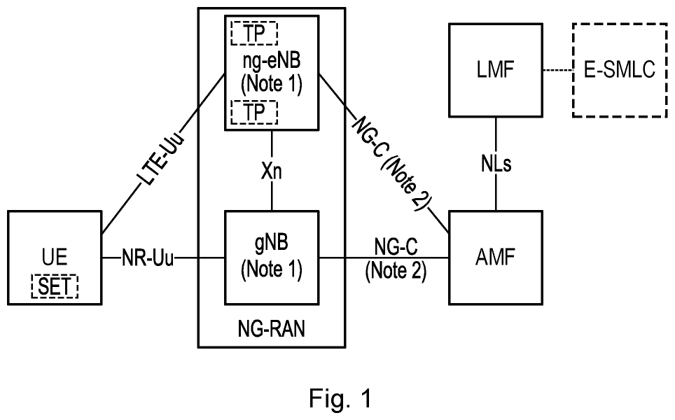

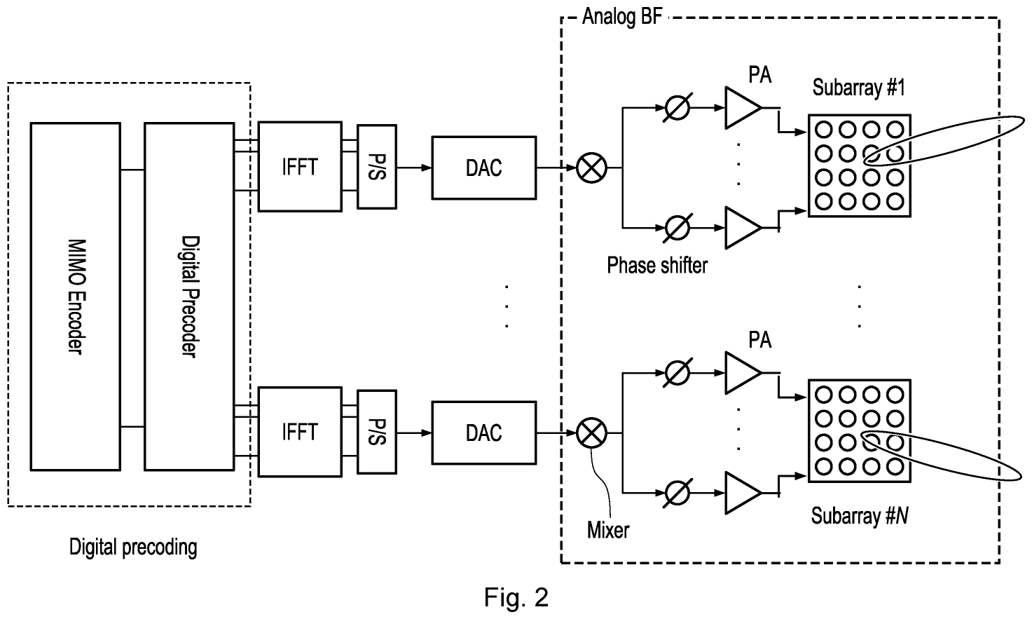

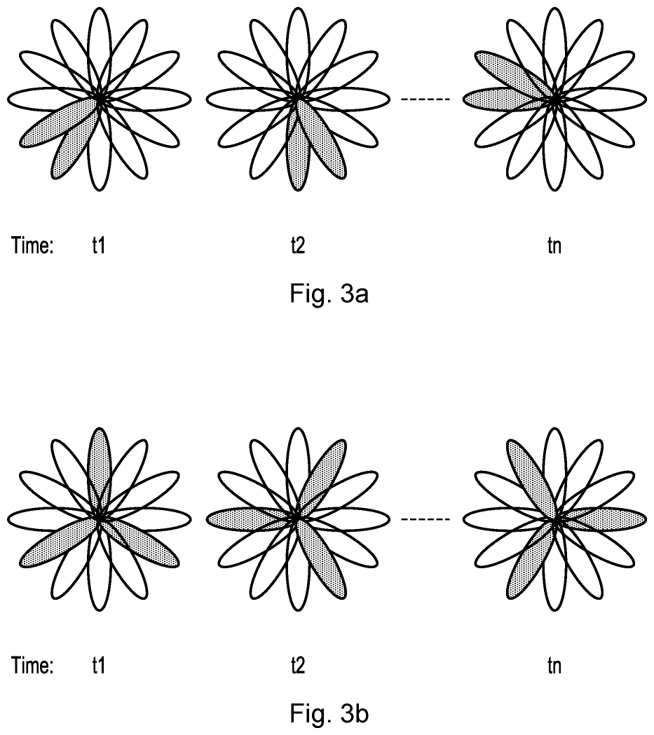

### DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Based upon the signaling procedure described above between the UE, the gNB and the LMF, various embodiments are presented below.

Presence of Spatial Relation

In one embodiment, an R bit is repurposed to indicate whether UE should expect any spatial relations or not. As shown below one of the R bits has been repurposed as “S” bit.

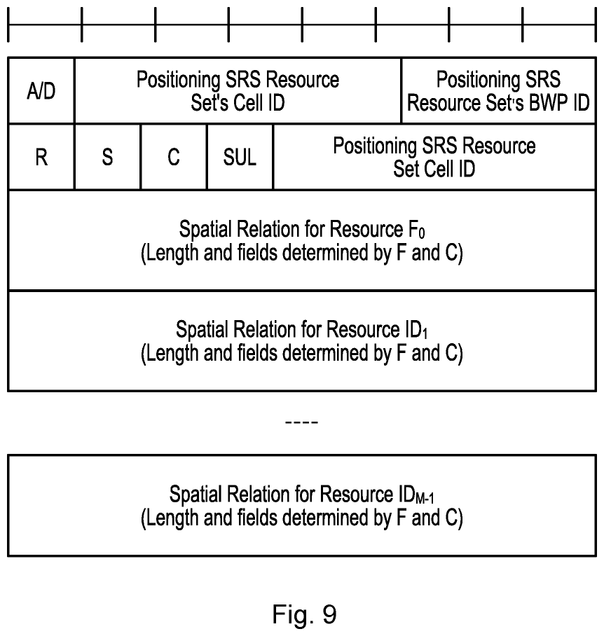

FIG. 9 illustrates SP Positioning SRS Activation/Deactivation MAC CE

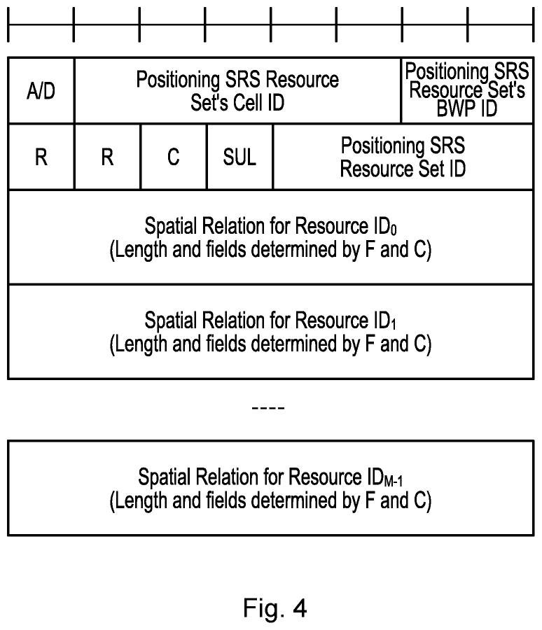

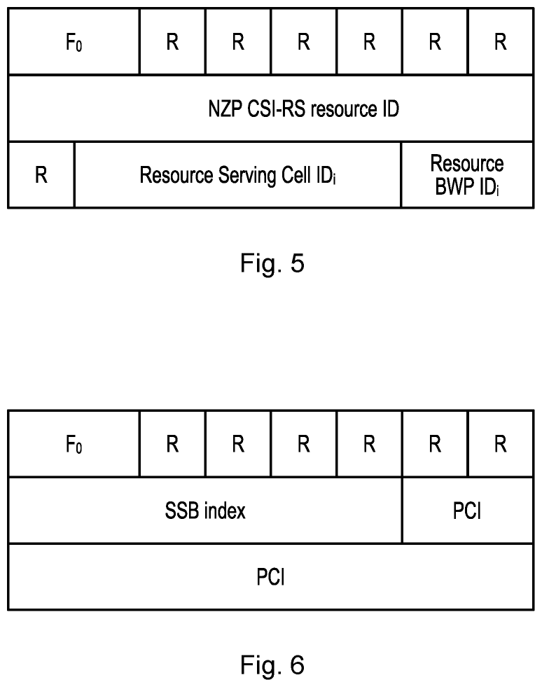

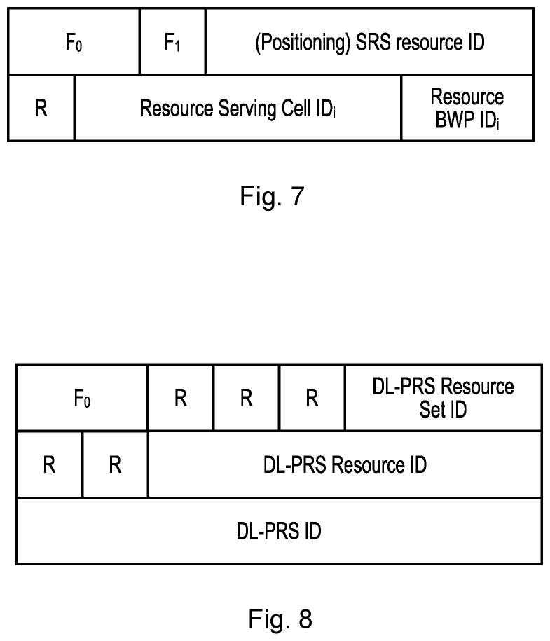

The SP Positioning SRS Activation/Deactivation MAC CE is as described above with reference to FIG. 4, except for the following:

Spatial Relation presence/absence S bit: When S is set to 0, the field indicates that SRS for spatial relation or positioning is not available. When S bit is set to 1, the field indicates that SRS for spatial relation is present.

Presence of Spatial Relation for all BWP

In a separate embodiment, an R bit is repurposed to inform the UE that the spatial relation is valid for all BWP. Otherwise as per current design, if network wants to set this per cell it has to send as many MAC CEs as UE has BWPs. The R field can be repurposed to say spatial relation is applicable “all BWPs”.

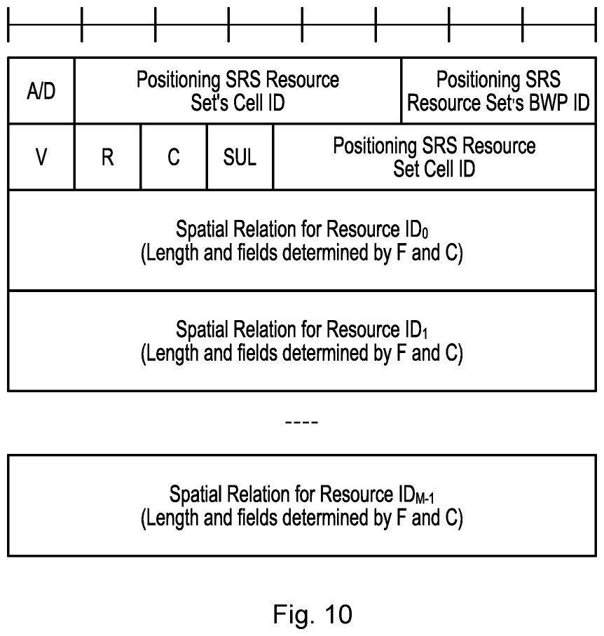

FIG. 10 illustrates SP Positioning SRS Activation/Deactivation MAC CE.

The SP Positioning SRS Activation/Deactivation MAC CE is as described above with reference to FIG. 4, except for the following:

All BWP presence/absence V bit: When V is set to 0, the field indicates that SRS for spatial relation or positioning is applicable/valid only for that BWP. When V bit is set to 1, the field indicates that SRS for spatial relation is applicable/valid for all BWP.

In another embodiment, one of the R bits is used similarly to indicate the MAC CE applies to all serving cells the UE is configured with.

In another embodiment, without using any of the fields in the MAC CE body, it can be specified that if the serving cell “Positioning SRS resource Set's Cell ID” belongs to a RRC configured list of serving cells named “List_of_simultaneous_activation_positioning_SRS_set”, the MAC CE applies to all serving cells of that list and all BWPs of those serving cells.

Resource ID Indicator

In a further embodiment, one of the R-bits can be repurposed to indicate if the DL-PRS ID is present or absence.

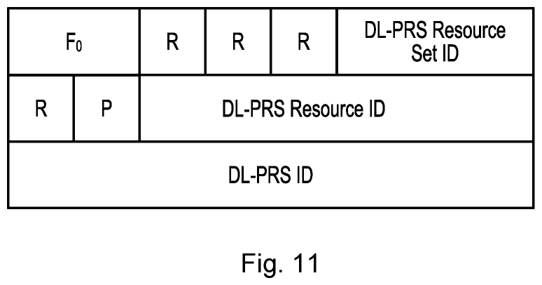

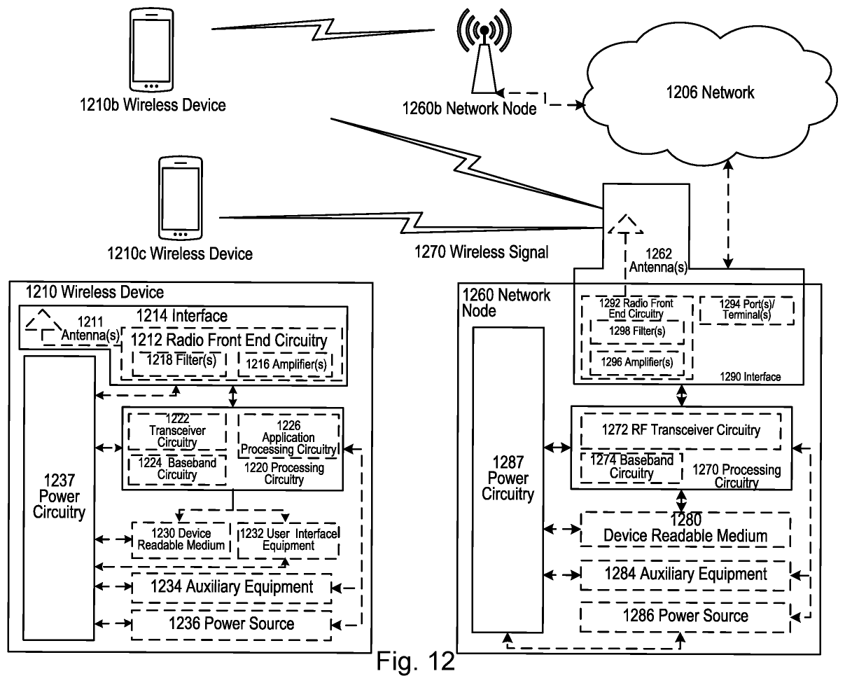

FIG. 11 illustrates Spatial Relation for Resource IDi with DL-PRS.

The Spatial Relation for Resource IDi with DL-PRS is as described above with reference to FIG. 8, except for the following:

DL-PRS ID presence/absence P bit: When P is set to 0, the field indicates that DL-PRS-ID is not provided. When P bit is set to 1, the field indicates that DL-PRS-ID is provided.

As per current behaviour it is expected that it will be provided so it can be so that the bit 0 is used to indicate presence and bit 1 can be used to indicate absence.

In some embodiments multiple R bits can be repurposed such that the combination of these multiple bits can indicate the presence or absence of spatial relations, and whether spatial relations are valid for every BWP. For example, two bits can be used to indicate this information, and one example of the meanings of the two bit values is:

00—>spatial relation absent

01—>spatial relation per BWP

10—>spatial relation valid for all BWP

11—>Reserved

Supplementary UL or Normal UL

A semi-persistent Supplementary Uplink (SUL) may also be configured as indicated by SUL field in the MAC CE. However, for the MAC entity to use this SUL, it should be known to the LMF and other listening nodes (such as the gNB, TRPs) that UL transmission is not in the normal UL but in the SUL.

In some embodiments, a serving gNB configures the UL carrier and it may prefer SUL or normal-UL. Further, the serving gNB may switch the carrier between SUL and normal UL.

In the MAC CE, the SUL field indicates whether the MAC CE applies to the NUL carrier or SUL carrier configuration. This field is set to 1 to indicate that it applies to the SUL carrier configuration, and it is set to 0 to indicate that it applies to the NUL carrier configuration.

Thus, a network node such as a gNB determines whether a Supplementary Uplink (SUL) or Normal Uplink (NUL) would be used for SRS for positioning transmission. The Supplementary UL may be in the FR1 region to improve coverage. Thus, if the UE is in poor coverage, SUL may be preferred. However, in FR1, the benefit that spatial relation would bring may diminish (because FR2 is primarily beam based) and beam based UL transmission based upon spatial relation info would be very focused. This may also minimize interference. In some scenarios FR2 may be preferred. In some cases, when a UE is moving, it may go from poor coverage to better coverage allowing the serving gNB to select the UL carrier accordingly (i.e. SUL or normal UL).

In one embodiment, the network node determines the selection of SUL or NUL (normal Uplink) and informs the selection, or the switch of the carrier, to the Location Management Function (LMF) in a New Radio Positioning Protocol A (NRPPa) protocol message. The existing NRPPa message is extended to include the selection of which UL carrier has been selected. This information is then used by LMF to provide information to other nodes (gNBs, TRPs). If there is switch between SUL and NUL, the listening node adjusts the listening carrier frequency accordingly.

In one embodiment, the LMF may recommend the selection between SUL and UL based upon UE measurement statistics such as UE Rx Tx measurement and the quality metrics associated with that. If the performance is poor in one carrier the LMF may suggest gNB to enable/switch SRS transmission to another carrier; switch from SUL to UL or vice versa.

The above procedures can be considered as a pre-requisite procedure before the MAC entity can use the SUL. If relaying of selection between SUL or NUL is not provided, the MAC entity is restricted to use only NUL. The higher layer such as signaling layer protocols (RRC, NRPPa) would know if signaling support is provided or not for the selection of SUL and NUL. Depending upon that Layer 3 may indicate to L2 (MAC layer) to use SUL else only NUL is used. Accordingly, the MAC layer uses the bit SUL.

Thus, some embodiments provide a mechanism where a serving gNB may determine which UL to use and relay this information to the LMF. The LMF then relays this information to listening nodes (other gNBs/TRPs).

FIG. 12 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 12. For simplicity, the wireless network of FIG. 12 only depicts network 1206, network nodes 1260 and 1260b, and WDs 1210, 1210b, and 1210c. In practice, a wireless network may further include any additional elements suitable to support communication between wireless devices or between a wireless device and another communication device, such as a landline telephone, a service provider, or any other network node or end device. Of the illustrated components, network node 1260 and wireless device (WD) 1210 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1206 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1260 and WD 1210 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 1260 includes processing circuitry 1270, device readable medium 1280, interface 1290, auxiliary equipment 1284, power source 1286, power circuitry 1287, and antenna 1262. Although network node 1260 illustrated in the example wireless network of FIG. 12 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1260 are depicted as single boxes located within a larger box, or nested within multiple boxes, in practice, a network node may comprise multiple different physical components that make up a single illustrated component (e.g., device readable medium 1280 may comprise multiple separate hard drives as well as multiple RAM modules).

Similarly, network node 1260 may be composed of multiple physically separate components (e.g., a NodeB component and a RNC component, or a BTS component and a BSC component, etc.), which may each have their own respective components. In certain scenarios in which network node 1260 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1260 may be configured to support multiple radio access technologies (RATs). In such embodiments, some components may be duplicated (e.g., separate device readable medium 1280 for the different RATs) and some components may be reused (e.g., the same antenna 1262 may be shared by the RATs). Network node 1260 may also include multiple sets of the various illustrated components for different wireless technologies integrated into network node 1260, such as, for example, GSM, WCDMA, LTE, NR, WiFi, or Bluetooth wireless technologies. These wireless technologies may be integrated into the same or different chip or set of chips and other components within network node 1260.

Processing circuitry 1270 is configured to perform any determining, calculating, or similar operations (e.g., certain obtaining operations) described herein as being provided by a network node. These operations performed by processing circuitry 1270 may include processing information obtained by processing circuitry 1270 by, for example, converting the obtained information into other information, comparing the obtained information or converted information to information stored in the network node, and/or performing one or more operations based on the obtained information or converted information, and as a result of said processing making a determination.

Processing circuitry 1270 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1260 components, such as device readable medium 1280, network node 1260 functionality. For example, processing circuitry 1270 may execute instructions stored in device readable medium 1280 or in memory within processing circuitry 1270. Such functionality may include providing any of the various wireless features, functions, or benefits discussed herein. In some embodiments, processing circuitry 1270 may include a system on a chip

In some embodiments, processing circuitry 1270 may include one or more of radio frequency (RF) transceiver circuitry 1272 and baseband processing circuitry 1274. In some embodiments, radio frequency (RF) transceiver circuitry 1272 and baseband processing circuitry 1274 may be on separate chips (or sets of chips), boards, or units, such as radio units and digital units. In alternative embodiments, part or all of RF transceiver circuitry 1272 and baseband processing circuitry 1274 may be on the same chip or set of chips, boards, or units

In certain embodiments, some or all of the functionality described herein as being provided by a network node, base station, eNB or other such network device may be performed by processing circuitry 1270 executing instructions stored on device readable medium 1280 or memory within processing circuitry 1270. In alternative embodiments, some or all of the functionality may be provided by processing circuitry 1270 without executing instructions stored on a separate or discrete device readable medium, such as in a hard-wired manner. In any of those embodiments, whether executing instructions stored on a device readable storage medium or not, processing circuitry 1270 can be configured to perform the described functionality. The benefits provided by such functionality are not limited to processing circuitry 1270 alone or to other components of network node 1260, but are enjoyed by network node 1260 as a whole, and/or by end users and the wireless network generally.

Device readable medium 1280 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1270. Device readable medium 1280 may store any suitable instructions, data or information, including a computer program, software, an application including one or more of logic, rules, code, tables, etc. and/or other instructions capable of being executed by processing circuitry 1270 and, utilized by network node 1260. Device readable medium 1280 may be used to store any calculations made by processing circuitry 1270 and/or any data received via interface 1290. In some embodiments, processing circuitry 1270 and device readable medium 1280 may be considered to be integrated.

Interface 1290 is used in the wired or wireless communication of signalling and/or data between network node 1260, network 1206, and/or WDs 1210. As illustrated, interface 1290 comprises port(s)/terminal(s) 1294 to send and receive data, for example to and from network 1206 over a wired connection. Interface 1290 also includes radio front end circuitry 1292 that may be coupled to, or in certain embodiments a part of, antenna 1262. Radio front end circuitry 1292 comprises filters 1298 and amplifiers 1296. Radio front end circuitry 1292 may be connected to antenna 1262 and processing circuitry 1270. Radio front end circuitry may be configured to condition signals communicated between antenna 1262 and processing circuitry 1270. Radio front end circuitry 1292 may receive digital data that is to be sent out to other network nodes or WDs via a wireless connection. Radio front end circuitry 1292 may convert the digital data into a radio signal having the appropriate channel and bandwidth parameters using a combination of filters 1298 and/or amplifiers 1296. The radio signal may then be transmitted via antenna 1262. Similarly, when receiving data, antenna 1262 may collect radio signals which are then converted into digital data by radio front end circuitry 1292. The digital data may be passed to processing circuitry 1270. In other embodiments, the interface may comprise different components and/or different combinations of components.

In certain alternative embodiments, network node 1260 may not include separate radio front end circuitry 1292, instead, processing circuitry 1270 may comprise radio front end circuitry and may be connected to antenna 1262 without separate radio front end circuitry 1292. Similarly, in some embodiments, all or some of RF transceiver circuitry 1272 may be considered a part of interface 1290. In still other embodiments, interface 1290 may include one or more ports or terminals 1294, radio front end circuitry 1292, and RF transceiver circuitry 1272, as part of a radio unit (not shown), and interface 1290 may communicate with baseband processing circuitry 1274, which is part of a digital unit (not shown).

Antenna 1262 may include one or more antennas, or antenna arrays, configured to send and/or receive wireless signals. Antenna 1262 may be coupled to radio front end circuitry 1290 and may be any type of antenna capable of transmitting and receiving data and/or signals wirelessly. In some embodiments, antenna 1262 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1262 may be separate from network node 1260 and may be connectable to network node 1260 through an interface or port.

Antenna 1262, interface 1290, and/or processing circuitry 1270 may be configured to perform any receiving operations and/or certain obtaining operations described herein as being performed by a network node. Any information, data and/or signals may be received from a wireless device, another network node and/or any other network equipment. Similarly, antenna 1262, interface 1290, and/or processing circuitry 1270 may be configured to perform any transmitting operations described herein as being performed by a network node. Any information, data and/or signals may be transmitted to a wireless device, another network node and/or any other network equipment.

Power circuitry 1287 may comprise, or be coupled to, power management circuitry and is configured to supply the components of network node 1260 with power for performing the functionality described herein. Power circuitry 1287 may receive power from power source 1286. Power source 1286 and/or power circuitry 1287 may be configured to provide power to the various components of network node 1260 in a form suitable for the respective components (e.g., at a voltage and current level needed for each respective component). Power source 1286 may either be included in, or external to, power circuitry 1287 and/or network node 1260. For example, network node 1260 may be connectable to an external power source (e.g., an electricity outlet) via an input circuitry or interface such as an electrical cable, whereby the external power source supplies power to power circuitry 1287. As a further example, power source 1286 may comprise a source of power in the form of a battery or battery pack which is connected to, or integrated in, power circuitry 1287. The battery may provide backup power should the external power source fail. Other types of power sources, such as photovoltaic devices, may also be used.

Alternative embodiments of network node 1260 may include additional components beyond those shown in FIG. 12 that may be responsible for providing certain aspects of the network node's functionality, including any of the functionality described herein and/or any functionality necessary to support the subject matter described herein. For example, network node 1260 may include user interface equipment to allow input of information into network node 1260 and to allow output of information from network node 1260. This may allow a user to perform diagnostic, maintenance, repair, and other administrative functions for network node 1260.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1210 includes antenna 1211, interface 1214, processing circuitry 1220, device readable medium 1230, user interface equipment 1232, auxiliary equipment 1234, power source 1236 and power circuitry 1237. WD 1210 may include multiple sets of one or more of the illustrated components for different wireless technologies supported by WD 1210, such as, for example, GSM, WCDMA, LTE, NR, WiFi, WiMAX, or Bluetooth wireless technologies, just to mention a few. These wireless technologies may be integrated into the same or different chips or set of chips as other components within WD 1210.

Antenna 1211 may include one or more antennas or antenna arrays, configured to send and/or receive wireless signals, and is connected to interface 1214. In certain alternative embodiments, antenna 1211 may be separate from WD 1210 and be connectable to WD 1210 through an interface or port. Antenna 1211, interface 1214, and/or processing circuitry 1220 may be configured to perform any receiving or transmitting operations described herein as being performed by a WD. Any information, data and/or signals may be received from a network node and/or another WD. In some embodiments, radio front end circuitry and/or antenna 1211 may be considered an interface.

As illustrated, interface 1214 comprises radio front end circuitry 1212 and antenna 1211. Radio front end circuitry 1212 comprise one or more filters 1218 and amplifiers 1216. Radio front end circuitry 1214 is connected to antenna 1211 and processing circuitry 1220, and is configured to condition signals communicated between antenna 1211 and processing circuitry 1220. Radio front end circuitry 1212 may be coupled to or a part of antenna 1211. In some embodiments, WD 1210 may not include separate radio front end circuitry 1212; rather, processing circuitry 1220 may comprise radio front end circuitry and may be connected to antenna 1211. Similarly, in some embodiments, some or all of RF transceiver circuitry 1222 may be considered a part of interface 1214. Radio front end circuitry 1212 may receive digital data that is to be sent out to other network nodes or WDs via a wireless connection. Radio front end circuitry 1212 may convert the digital data into a radio signal having the appropriate channel and bandwidth parameters using a combination of filters 1218 and/or amplifiers 1216. The radio signal may then be transmitted via antenna 1211. Similarly, when receiving data, antenna 1211 may collect radio signals which are then converted into digital data by radio front end circuitry 1212. The digital data may be passed to processing circuitry 1220. In other embodiments, the interface may comprise different components and/or different combinations of components.

Processing circuitry 1220 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1210 components, such as device readable medium 1230, WD 1210 functionality. Such functionality may include providing any of the various wireless features or benefits discussed herein. For example, processing circuitry 1220 may execute instructions stored in device readable medium 1230 or in memory within processing circuitry 1220 to provide the functionality disclosed herein.

As illustrated, processing circuitry 1220 includes one or more of RF transceiver circuitry 1222, baseband processing circuitry 1224, and application processing circuitry 1226. In other embodiments, the processing circuitry may comprise different components and/or different combinations of components. In certain embodiments processing circuitry 1220 of WD 1210 may comprise a SOC. In some embodiments, RF transceiver circuitry 1222, baseband processing circuitry 1224, and application processing circuitry 1226 may be on separate chips or sets of chips. In alternative embodiments, part or all of baseband processing circuitry 1224 and application processing circuitry 1226 may be combined into one chip or set of chips, and RF transceiver circuitry 1222 may be on a separate chip or set of chips. In still alternative embodiments, part or all of RF transceiver circuitry 1222 and baseband processing circuitry 1224 may be on the same chip or set of chips, and application processing circuitry 1226 may be on a separate chip or set of chips. In yet other alternative embodiments, part or all of RF transceiver circuitry 1222, baseband processing circuitry 1224, and application processing circuitry 1226 may be combined in the same chip or set of chips. In some embodiments, RF transceiver circuitry 1222 may be a part of interface 1214. RF transceiver circuitry 1222 may condition RF signals for processing circuitry 1220.

In certain embodiments, some or all of the functionality described herein as being performed by a WD may be provided by processing circuitry 1220 executing instructions stored on device readable medium 1230, which in certain embodiments may be a computer-readable storage medium. In alternative embodiments, some or all of the functionality may be provided by processing circuitry 1220 without executing instructions stored on a separate or discrete device readable storage medium, such as in a hard-wired manner. In any of those particular embodiments, whether executing instructions stored on a device readable storage medium or not, processing circuitry 1220 can be configured to perform the described functionality. The benefits provided by such functionality are not limited to processing circuitry 1220 alone or to other components of WD 1210, but are enjoyed by WD 1210 as a whole, and/or by end users and the wireless network generally.

Processing circuitry 1220 may be configured to perform any determining, calculating, or similar operations (e.g., certain obtaining operations) described herein as being performed by a WD. These operations, as performed by processing circuitry 1220, may include processing information obtained by processing circuitry 1220 by, for example, converting the obtained information into other information, comparing the obtained information or converted information to information stored by WD 1210, and/or performing one or more operations based on the obtained information or converted information, and as a result of said processing making a determination.

Device readable medium 1230 may be operable to store a computer program, software, an application including one or more of logic, rules, code, tables, etc. and/or other instructions capable of being executed by processing circuitry 1220. Device readable medium 1230 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1220. In some embodiments, processing circuitry 1220 and device readable medium 1230 may be considered to be integrated.

User interface equipment 1232 may provide components that allow for a human user to interact with WD 1210. Such interaction may be of many forms, such as visual, audial, tactile, etc. User interface equipment 1232 may be operable to produce output to the user and to allow the user to provide input to WD 1210. The type of interaction may vary depending on the type of user interface equipment 1232 installed in WD 1210. For example, if WD 1210 is a smart phone, the interaction may be via a touch screen; if WD 1210 is a smart meter, the interaction may be through a screen that provides usage (e.g., the number of gallons used) or a speaker that provides an audible alert (e.g., if smoke is detected). User interface equipment 1232 may include input interfaces, devices and circuits, and output interfaces, devices and circuits. User interface equipment 1232 is configured to allow input of information into WD 1210, and is connected to processing circuitry 1220 to allow processing circuitry 1220 to process the input information. User interface equipment 1232 may include, for example, a microphone, a proximity or other sensor, keys/buttons, a touch display, one or more cameras, a USB port, or other input circuitry. User interface equipment 1232 is also configured to allow output of information from WD 1210, and to allow processing circuitry 1220 to output information from WD 1210. User interface equipment 1232 may include, for example, a speaker, a display, vibrating circuitry, a USB port, a headphone interface, or other output circuitry. Using one or more input and output interfaces, devices, and circuits, of user interface equipment 1232, WD 1210 may communicate with end users and/or the wireless network, and allow them to benefit from the functionality described herein.

Auxiliary equipment 1234 is operable to provide more specific functionality which may not be generally performed by WDs. This may comprise specialized sensors for doing measurements for various purposes, interfaces for additional types of communication such as wired communications etc. The inclusion and type of components of auxiliary equipment 1234 may vary depending on the embodiment and/or scenario.

Power source 1236 may, in some embodiments, be in the form of a battery or battery pack. Other types of power sources, such as an external power source (e.g., an electricity outlet), photovoltaic devices or power cells, may also be used. WD 1210 may further comprise power circuitry 1237 for delivering power from power source 1236 to the various parts of WD 1210 which need power from power source 1236 to carry out any functionality described or indicated herein. Power circuitry 1237 may in certain embodiments comprise power management circuitry. Power circuitry 1237 may additionally or alternatively be operable to receive power from an external power source; in which case WD 1210 may be connectable to the external power source (such as an electricity outlet) via input circuitry or an interface such as an electrical power cable. Power circuitry 1237 may also in certain embodiments be operable to deliver power from an external power source to power source 1236. This may be, for example, for the charging of power source 1236. Power circuitry 1237 may perform any formatting, converting, or other modification to the power from power source 1236 to make the power suitable for the respective components of WD 1210 to which power is supplied.

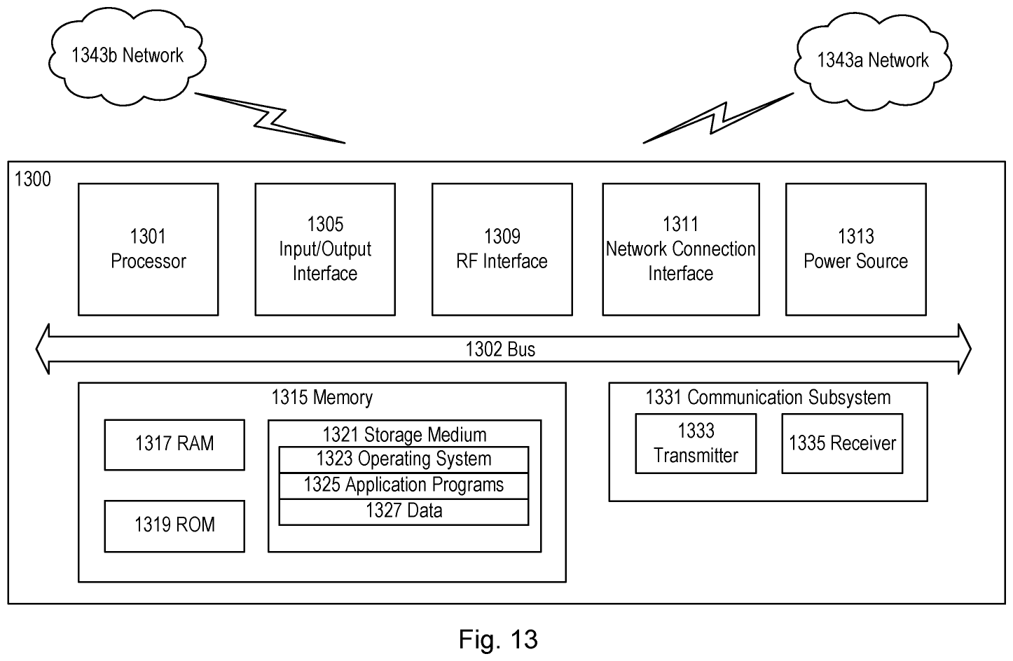

FIG. 13 illustrates a User Equipment in accordance with some embodiments

FIG. 13 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1300 may be any UE identified by the 3^{rd} Generation Partnership Project (3GPP), including a NB-IoT UE, a machine type communication (MTC) UE, and/or an enhanced MTC (eMTC) UE. UE 1300, as illustrated in FIG. 13, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 1300 includes processing circuitry 1301 that is operatively coupled to input/output interface 1305, radio frequency (RF) interface 1309, network connection interface 1311, memory 1315 including random access memory (RAM) 1317, read-only memory (ROM) 1319, and storage medium 1321 or the like, communication subsystem 1331, power source 1333, and/or any other component, or any combination thereof. Storage medium 1321 includes operating system 1323, application program 1325, and data 1327. In other embodiments, storage medium 1321 may include other similar types of information. Certain UEs may utilize all of the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 1301 may be configured to process computer instructions and data. Processing circuitry 1301 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1301 may include two central processing units (CPUs). Data may be information in a form suitable for use by a computer.

In the depicted embodiment, input/output interface 1305 may be configured to provide a communication interface to an input device, output device, or input and output device. UE 1300 may be configured to use an output device via input/output interface 1305. An output device may use the same type of interface port as an input device. For example, a USB port may be used to provide input to and output from UE 1300. The output device may be a speaker, a sound card, a video card, a display, a monitor, a printer, an actuator, an emitter, a smartcard, another output device, or any combination thereof. UE 1300 may be configured to use an input device via input/output interface 1305 to allow a user to capture information into UE 1300. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 1309 may be configured to provide a communication interface to RF components such as a transmitter, a receiver, and an antenna. Network connection interface 1311 may be configured to provide a communication interface to network 1343a. Network 1343a may encompass wired and/or wireless networks such as a local-area network (LAN), a wide-area network (WAN), a computer network, a wireless network, a telecommunications network, another like network or any combination thereof. For example, network 1343a may comprise a Wi-Fi network. Network connection interface 1311 may be configured to include a receiver and a transmitter interface used to communicate with one or more other devices over a communication network according to one or more communication protocols, such as Ethernet, TCP/IP, SONET, ATM, or the like. Network connection interface 1311 may implement receiver and transmitter functionality appropriate to the communication network links (e.g., optical, electrical, and the like). The transmitter and receiver functions may share circuit components, software or firmware, or alternatively may be implemented separately.

RAM 1317 may be configured to interface via bus 1302 to processing circuitry 1301 to provide storage or caching of data or computer instructions during the execution of software programs such as the operating system, application programs, and device drivers. ROM 1319 may be configured to provide computer instructions or data to processing circuitry 1301. For example, ROM 1319 may be configured to store invariant low-level system code or data for basic system functions such as basic input and output (I/O), startup, or reception of keystrokes from a keyboard that are stored in a non-volatile memory. Storage medium 1321 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1321 may be configured to include operating system 1323, application program 1325 such as a web browser application, a widget or gadget engine or another application, and data file 1327. Storage medium 1321 may store, for use by UE 1300, any of a variety of various operating systems or combinations of operating systems.

Storage medium 1321 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1321 may allow UE 1300 to access computer-executable instructions, application programs or the like, stored on transitory or non-transitory memory media, to off-load data, or to upload data. An article of manufacture, such as one utilizing a communication system may be tangibly embodied in storage medium 1321, which may comprise a device readable medium.

In FIG. 13, processing circuitry 1301 may be configured to communicate with network 1343b using communication subsystem 1331. Network 1343a and network 1343b may be the same network or networks or different network or networks. Communication subsystem 1331 may be configured to include one or more transceivers used to communicate with network 1343b. For example, communication subsystem 1331 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1333 and/or receiver 1335 to implement transmitter or receiver functionality, respectively, appropriate to the RAN links (e.g., frequency allocations and the like). Further, transmitter 1333 and receiver 1335 of each transceiver may share circuit components, software or firmware, or alternatively may be implemented separately.

In the illustrated embodiment, the communication functions of communication subsystem 1331 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1331 may include cellular communication, Wi-Fi communication, Bluetooth communication, and GPS communication. Network 1343b may encompass wired and/or wireless networks such as a local-area network (LAN), a wide-area network (WAN), a computer network, a wireless network, a telecommunications network, another like network or any combination thereof. For example, network 1343b may be a cellular network, a Wi-Fi network, and/or a near-field network. Power source 1313 may be configured to provide alternating current (AC) or direct current (DC) power to components of UE 1300.

The features, benefits and/or functions described herein may be implemented in one of the components of UE 1300 or partitioned across multiple components of UE 1300. Further, the features, benefits, and/or functions described herein may be implemented in any combination of hardware, software or firmware. In one example, communication subsystem 1331 may be configured to include any of the components described herein. Further, processing circuitry 1301 may be configured to communicate with any of such components over bus 1302. In another example, any of such components may be represented by program instructions stored in memory that when executed by processing circuitry 1301 perform the corresponding functions described herein. In another example, the functionality of any of such components may be partitioned between processing circuitry 1301 and communication subsystem 1331. In another example, the non-computationally intensive functions of any of such components may be implemented in software or firmware and the computationally intensive functions may be implemented in hardware.

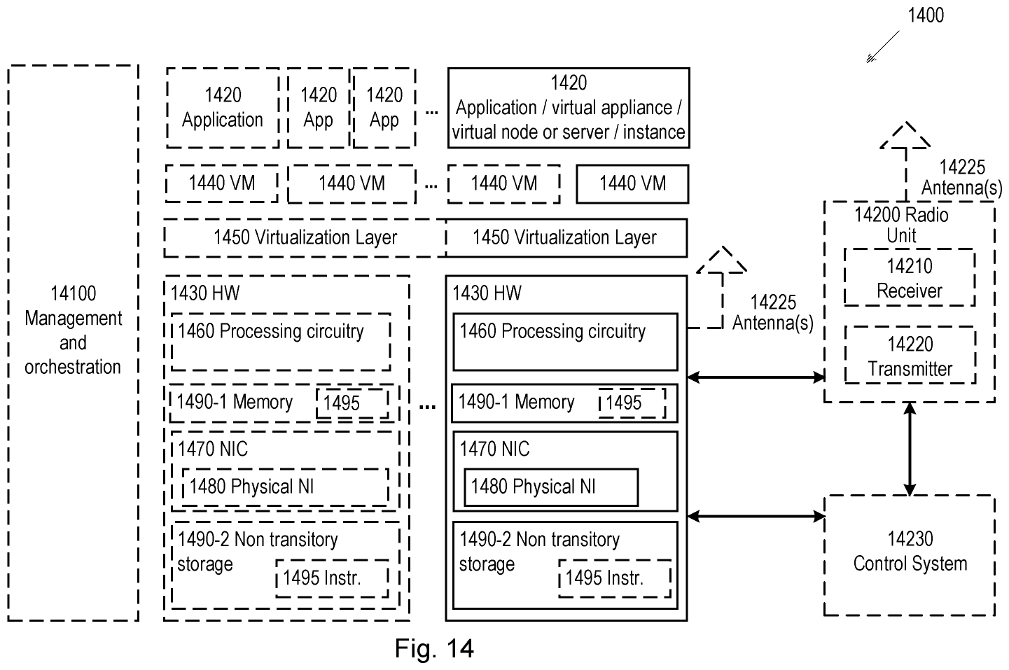

FIG. 14 illustrates a Virtualization environment in accordance with some embodiments

FIG. 14 is a schematic block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1400 hosted by one or more of hardware nodes 1430. Further, in embodiments in which the virtual node is not a radio access node or does not require radio connectivity (e.g., a core network node), then the network node may be entirely virtualized.

The functions may be implemented by one or more applications 1420 (which may alternatively be called software instances, virtual appliances, network functions, virtual nodes, virtual network functions, etc.) operative to implement some of the features, functions, and/or benefits of some of the embodiments disclosed herein. Applications 1420 are run in virtualization environment 1400 which provides hardware 1430 comprising processing circuitry 1460 and memory 1490. Memory 1490 contains instructions 1495 executable by processing circuitry 1460 whereby application 1420 is operative to provide one or more of the features, benefits, and/or functions disclosed herein.

Virtualization environment 1400, comprises general-purpose or special-purpose network hardware devices 1430 comprising a set of one or more processors or processing circuitry 1460, which may be commercial off-the-shelf (COTS) processors, dedicated Application Specific Integrated Circuits (ASICs), or any other type of processing circuitry including digital or analog hardware components or special purpose processors. Each hardware device may comprise memory 1490-1 which may be non-persistent memory for temporarily storing instructions 1495 or software executed by processing circuitry 1460. Each hardware device may comprise one or more network interface controllers (NICs) 1470, also known as network interface cards, which include physical network interface 1480. Each hardware device may also include non-transitory, persistent, machine-readable storage media 1490-2 having stored therein software 1495 and/or instructions executable by processing circuitry 1460. Software 1495 may include any type of software including software for instantiating one or more virtualization layers 1450 (also referred to as hypervisors), software to execute virtual machines 1440 as well as software allowing it to execute functions, features and/or benefits described in relation with some embodiments described herein.

Virtual machines 1440, comprise virtual processing, virtual memory, virtual networking or interface and virtual storage, and may be run by a corresponding virtualization layer 1450 or hypervisor. Different embodiments of the instance of virtual appliance 1420 may be implemented on one or more of virtual machines 1440, and the implementations may be made in different ways.

During operation, processing circuitry 1460 executes software 1495 to instantiate the hypervisor or virtualization layer 1450, which may sometimes be referred to as a virtual machine monitor (VMM). Virtualization layer 1450 may present a virtual operating platform that appears like networking hardware to virtual machine 1440.

As shown in FIG. 14, hardware 1430 may be a standalone network node with generic or specific components. Hardware 1430 may comprise antenna 14225 and may implement some functions via virtualization. Alternatively, hardware 1430 may be part of a larger cluster of hardware (e.g. such as in a data center or customer premise equipment (CPE)) where many hardware nodes work together and are managed via management and orchestration (MANO) 14100, which, among others, oversees lifecycle management of applications 1420.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1440 may be a software implementation of a physical machine that runs programs as if they were executing on a physical, non-virtualized machine. Each of virtual machines 1440, and that part of hardware 1430 that executes that virtual machine, be it hardware dedicated to that virtual machine and/or hardware shared by that virtual machine with others of the virtual machines 1440, forms a separate virtual network elements (VNE).

Still in the context of NFV, Virtual Network Function (VNF) is responsible for handling specific network functions that run in one or more virtual machines 1440 on top of hardware networking infrastructure 1430 and corresponds to application 1420 in FIG. 14.

In some embodiments, one or more radio units 14200 that each include one or more transmitters 14220 and one or more receivers 14210 may be coupled to one or more antennas 14225. Radio units 14200 may communicate directly with hardware nodes 1430 via one or more appropriate network interfaces and may be used in combination with the virtual components to provide a virtual node with radio capabilities, such as a radio access node or a base station.

In some embodiments, some signalling can be effected with the use of control system 14230 which may alternatively be used for communication between the hardware nodes 1430 and radio units 14200.

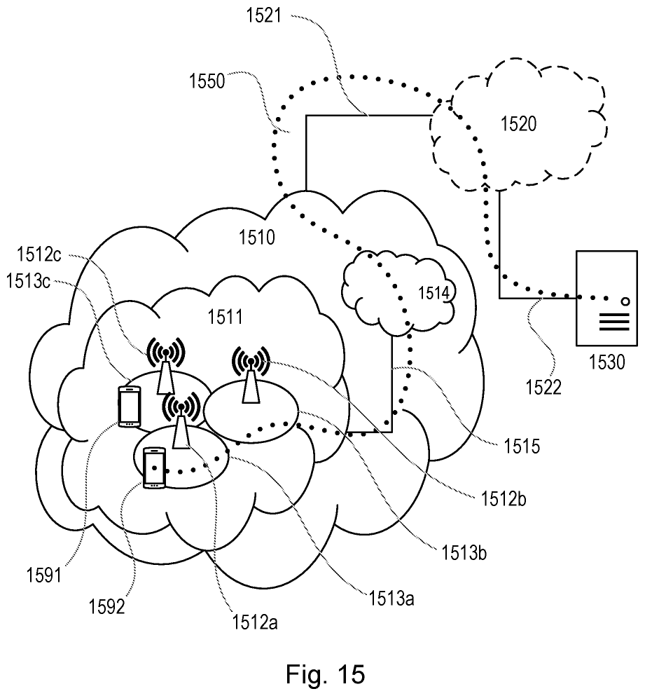

FIG. 15 illustrates a Telecommunication network connected via an intermediate network to a host computer in accordance with some embodiments.

With reference to FIG. 15, in accordance with an embodiment, a communication system includes telecommunication network 1510, such as a 3GPP-type cellular network, which comprises access network 1511, such as a radio access network, and core network 1514. Access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to core network 1514 over a wired or wireless connection 1515. A first UE 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

Telecommunication network 1510 is itself connected to host computer 1530, which may be embodied in the hardware and/or software of a standalone server, a cloud-implemented server, a distributed server or as processing resources in a server farm. Host computer 1530 may be under the ownership or control of a service provider, or may be operated by the service provider or on behalf of the service provider. Connections 1521 and 1522 between telecommunication network 1510 and host computer 1530 may extend directly from core network 1514 to host computer 1530 or may go via an optional intermediate network 1520. Intermediate network 1520 may be one of, or a combination of more than one of, a public, private or hosted network; intermediate network 1520, if any, may be a backbone network or the Internet; in particular, intermediate network 1520 may comprise two or more sub-networks (not shown).

The communication system of FIG. 15 as a whole enables connectivity between the connected UEs 1591, 1592 and host computer 1530. The connectivity may be described as an over-the-top (OTT) connection 1550. Host computer 1530 and the connected UEs 1591, 1592 are configured to communicate data and/or signaling via OTT connection 1550, using access network 1511, core network 1514, any intermediate network 1520 and possible further infrastructure (not shown) as intermediaries. OTT connection 1550 may be transparent in the sense that the participating communication devices through which OTT connection 1550 passes are unaware of routing of uplink and downlink communications. For example, base station 1512 may not or need not be informed about the past routing of an incoming downlink communication with data originating from host computer 1530 to be forwarded (e.g., handed over) to a connected UE 1591. Similarly, base station 1512 need not be aware of the future routing of an outgoing uplink communication originating from the UE 1591 towards the host computer 1530.

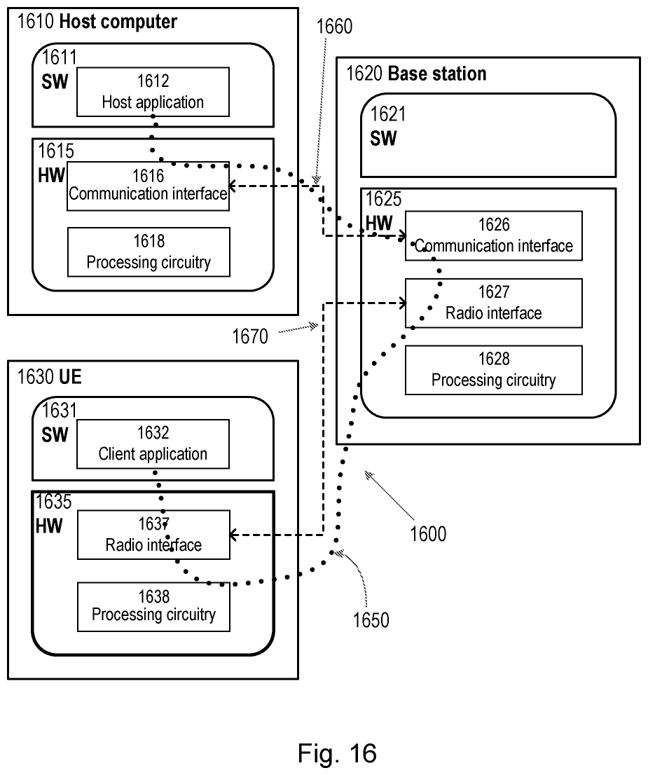

FIG. 16 illustrates a Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 16. In communication system 1600, host computer 1610 comprises hardware 1615 including communication interface 1616 configured to set up and maintain a wired or wireless connection with an interface of a different communication device of communication system 1600. Host computer 1610 further comprises processing circuitry 1618, which may have storage and/or processing capabilities. In particular, processing circuitry 1618 may comprise one or more programmable processors, application-specific integrated circuits, field programmable gate arrays or combinations of these (not shown) adapted to execute instructions. Host computer 1610 further comprises software 1611, which is stored in or accessible by host computer 1610 and executable by processing circuitry 1618. Software 1611 includes host application 1612. Host application 1612 may be operable to provide a service to a remote user, such as UE 1630 connecting via OTT connection 1650 terminating at UE 1630 and host computer 1610. In providing the service to the remote user, host application 1612 may provide user data which is transmitted using OTT connection 1650.

Communication system 1600 further includes base station 1620 provided in a telecommunication system and comprising hardware 1625 enabling it to communicate with host computer 1610 and with UE 1630. Hardware 1625 may include communication interface 1626 for setting up and maintaining a wired or wireless connection with an interface of a different communication device of communication system 1600, as well as radio interface 1627 for setting up and maintaining at least wireless connection 1670 with UE 1630 located in a coverage area (not shown in FIG. 16) served by base station 1620. Communication interface 1626 may be configured to facilitate connection 1660 to host computer 1610. Connection 1660 may be direct or it may pass through a core network (not shown in FIG. 16) of the telecommunication system and/or through one or more intermediate networks outside the telecommunication system. In the embodiment shown, hardware 1625 of base station 1620 further includes processing circuitry 1628, which may comprise one or more programmable processors, application-specific integrated circuits, field programmable gate arrays or combinations of these (not shown) adapted to execute instructions. Base station 1620 further has software 1621 stored internally or accessible via an external connection.

Communication system 1600 further includes UE 1630 already referred to. Its hardware 1635 may include radio interface 1637 configured to set up and maintain wireless connection 1670 with a base station serving a coverage area in which UE 1630 is currently located. Hardware 1635 of UE 1630 further includes processing circuitry 1638, which may comprise one or more programmable processors, application-specific integrated circuits, field programmable gate arrays or combinations of these (not shown) adapted to execute instructions. UE 1630 further comprises software 1631, which is stored in or accessible by UE 1630 and executable by processing circuitry 1638. Software 1631 includes client application 1632. Client application 1632 may be operable to provide a service to a human or non-human user via UE 1630, with the support of host computer 1610. In host computer 1610, an executing host application 1612 may communicate with the executing client application 1632 via OTT connection 1650 terminating at UE 1630 and host computer 1610. In providing the service to the user, client application 1632 may receive request data from host application 1612 and provide user data in response to the request data. OTT connection 1650 may transfer both the request data and the user data. Client application 1632 may interact with the user to generate the user data that it provides.

It is noted that host computer 1610, base station 1620 and UE 1630 illustrated in FIG. 16 may be similar or identical to host computer 1530, one of base stations 1512a, 1512b, 1512c and one of UEs 1591, 1592 of FIG. 15, respectively. This is to say, the inner workings of these entities may be as shown in FIG. 16 and independently, the surrounding network topology may be that of FIG. 15.

In FIG. 16, OTT connection 1650 has been drawn abstractly to illustrate the communication between host computer 1610 and UE 1630 via base station 1620, without explicit reference to any intermediary devices and the precise routing of messages via these devices. Network infrastructure may determine the routing, which it may be configured to hide from UE 1630 or from the service provider operating host computer 1610, or both. While OTT connection 1650 is active, the network infrastructure may further take decisions by which it dynamically changes the routing (e.g., on the basis of load balancing consideration or reconfiguration of the network).

Wireless connection 1670 between UE 1630 and base station 1620 is in accordance with the teachings of the embodiments described throughout this disclosure. One or more of the various embodiments improve the performance of OTT services provided to UE 1630 using OTT connection 1650, in which wireless connection 1670 forms the last segment. More precisely, the teachings of these embodiments may improve the data rate, latency, and/or power consumption, and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1650 between host computer 1610 and UE 1630, in response to variations in the measurement results. The measurement procedure and/or the network functionality for reconfiguring OTT connection 1650 may be implemented in software 1611 and hardware 1615 of host computer 1610 or in software 1631 and hardware 1635 of UE 1630, or both. In embodiments, sensors (not shown) may be deployed in or in association with communication devices through which OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of OTT connection 1650 may include message format, retransmission settings, preferred routing etc.; the reconfiguring need not affect base station 1620, and it may be unknown or imperceptible to base station 1620. Such procedures and functionalities may be known and practiced in the art. In certain embodiments, measurements may involve proprietary UE signaling facilitating host computer 1610's measurements of throughput, propagation times, latency and the like.

The measurements may be implemented in that software 1611 and 1631 causes messages to be transmitted, in particular empty or ‘dummy’ messages, using OTT connection 1650 while it monitors propagation times, errors etc.

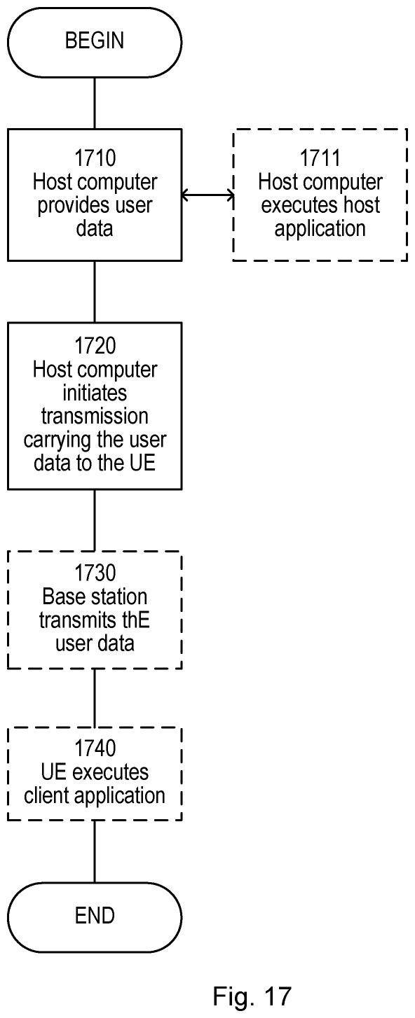

FIG. 17 illustrates methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In step 1710, the host computer provides user data. In substep 1711 (which may be optional) of step 1710, the host computer provides the user data by executing a host application. In step 1720, the host computer initiates a transmission carrying the user data to the UE. In step 1730 (which may be optional), the base station transmits to the UE the user data which was carried in the transmission that the host computer initiated, in accordance with the teachings of the embodiments described throughout this disclosure. In step 1740 (which may also be optional), the UE executes a client application associated with the host application executed by the host computer.

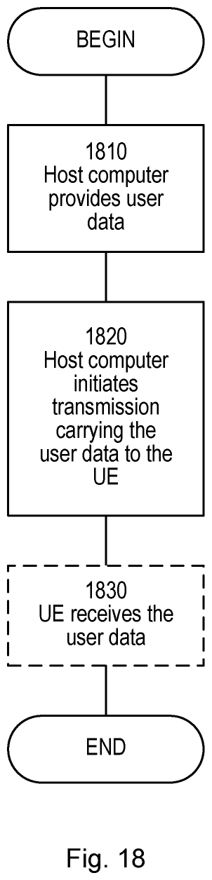

FIG. 18 illustrates methods implemented in a communication system including a host computer, a base station and a user equipment in accordance with some embodiments

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In step 1810 of the method, the host computer provides user data. In an optional substep (not shown) the host computer provides the user data by executing a host application. In step 1820, the host computer initiates a transmission carrying the user data to the UE. The transmission may pass via the base station, in accordance with the teachings of the embodiments described throughout this disclosure. In step 1830 (which may be optional), the UE receives the user data carried in the transmission.

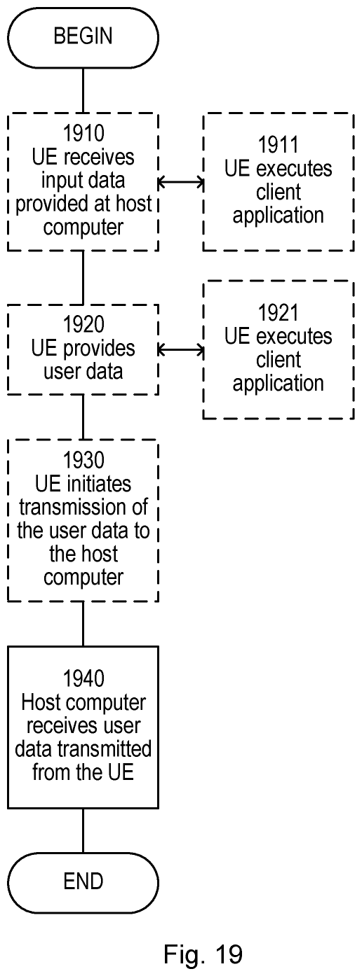

FIG. 19 illustrates methods implemented in a communication system including a host computer, a base station and a user equipment in accordance with some embodiments

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In step 1910 (which may be optional), the UE receives input data provided by the host computer. Additionally or alternatively, in step 1920, the UE provides user data. In substep 1921 (which may be optional) of step 1920, the UE provides the user data by executing a client application. In substep 1911 (which may be optional) of step 1910, the UE executes a client application which provides the user data in reaction to the received input data provided by the host computer. In providing the user data, the executed client application may further consider user input received from the user. Regardless of the specific manner in which the user data was provided, the UE initiates, in substep 1930 (which may be optional), transmission of the user data to the host computer. In step 1940 of the method, the host computer receives the user data transmitted from the UE, in accordance with the teachings of the embodiments described throughout this disclosure.

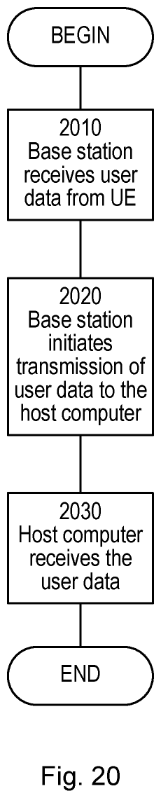

FIG. 20 illustrates methods implemented in a communication system including a host computer, a base station and a user equipment in accordance with some embodiments

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In step 2010 (which may be optional), in accordance with the teachings of the embodiments described throughout this disclosure, the base station receives user data from the UE. In step 2020 (which may be optional), the base station initiates transmission of the received user data to the host computer. In step 2030 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

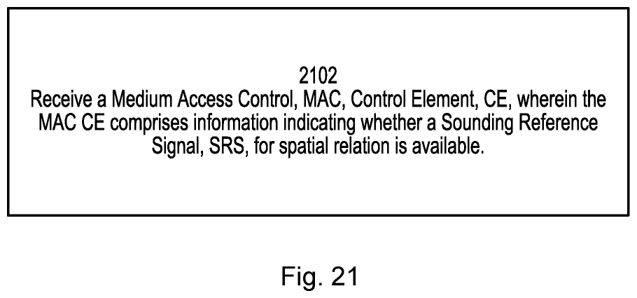

FIG. 21 illustrates a method in accordance with some embodiments

FIG. 21 depicts a method performed by a wireless device. In accordance with particular embodiments, the method comprises step 2102 of receiving a Medium Access Control, MAC, Control Element, CE, wherein the MAC CE comprises information indicating whether a Sounding Reference Signal, SRS, for spatial relation is available.

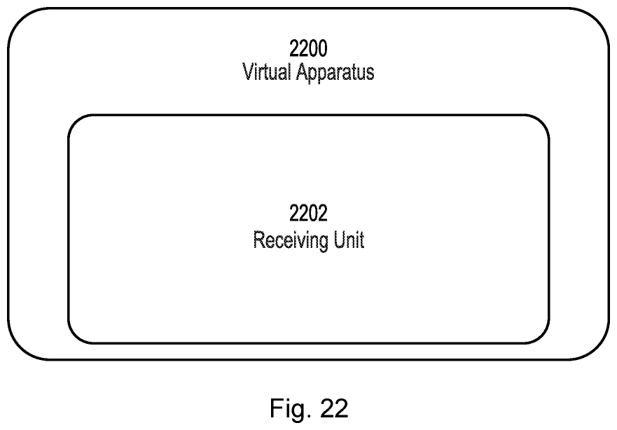

FIG. 22 illustrates a virtualization apparatus in accordance with some embodiments

FIG. 22 illustrates a schematic block diagram of an apparatus 2200 in a wireless network (for example, the wireless network shown in FIG. 12). The apparatus may be implemented in a wireless device or network node (e.g., wireless device 1210 or network node 1260 shown in FIG. 12). Apparatus 2200 is operable to carry out the example method described with reference to FIG. 21 and possibly any other processes or methods disclosed herein. It is also to be understood that the method of FIG. 21 is not necessarily carried out solely by apparatus 2200. At least some operations of the method can be performed by one or more other entities.

Virtual Apparatus 2200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2202 and any other suitable units of apparatus 2200 to perform corresponding functions according one or more embodiments of the present disclosure.

As illustrated in FIG. 22, apparatus 2200 includes receiving unit 2202, which is configured to receive a Medium Access Control, MAC, Control Element, CE, wherein the MAC CE comprises information indicating whether a Sounding Reference Signal, SRS, for spatial relation is available.

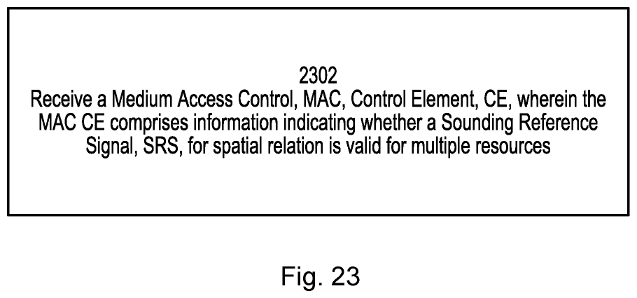

FIG. 23 illustrates a method in accordance with some embodiments

FIG. 23 depicts a method performed by a wireless device. In accordance with particular embodiments, the method comprises step 2302 of receiving a Medium Access Control, MAC, Control Element, CE, wherein the MAC CE comprises information indicating whether a Sounding Reference Signal, SRS, for spatial relation is valid for multiple resources.

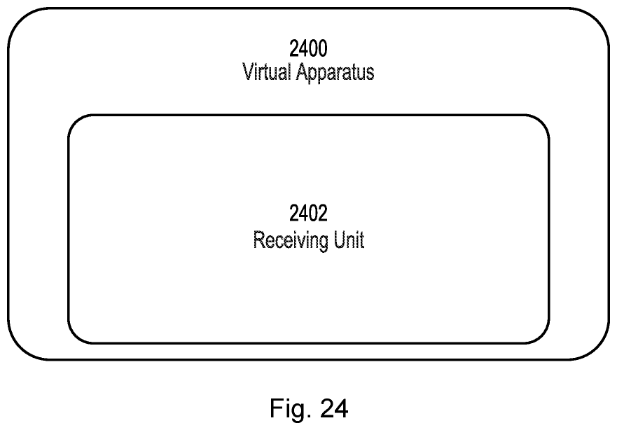

FIG. 24 illustrates a virtualization apparatus in accordance with some embodiments

FIG. 24 illustrates a schematic block diagram of an apparatus 2400 in a wireless network (for example, the wireless network shown in FIG. 12). The apparatus may be implemented in a wireless device or network node (e.g., wireless device 1210 or network node 1260 shown in FIG. 12). Apparatus 2400 is operable to carry out the example method described with reference to FIG. 23 and possibly any other processes or methods disclosed herein. It is also to be understood that the method of FIG. 23 is not necessarily carried out solely by apparatus 2400. At least some operations of the method can be performed by one or more other entities.

Virtual Apparatus 2400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2402 and any other suitable units of apparatus 2400 to perform corresponding functions according one or more embodiments of the present disclosure.

As illustrated in FIG. 24, apparatus 2400 includes receiving unit 2402, which is configured to receive a Medium Access Control, MAC, Control Element, CE, wherein the MAC CE comprises information indicating whether a Sounding Reference Signal, SRS, for spatial relation is valid for multiple resources.

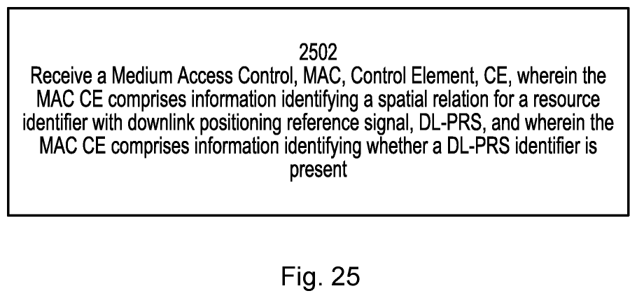

FIG. 25 illustrates a method in accordance with some embodiments

FIG. 25 depicts a method performed by a wireless device in accordance with particular embodiments. The method comprises step 2502 of receiving a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.

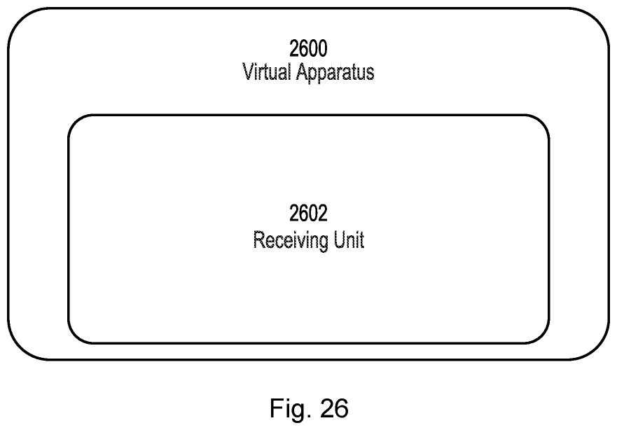

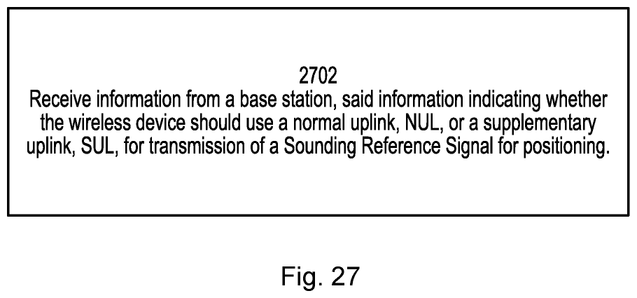

FIG. 26 illustrates a virtualization apparatus in accordance with some embodiments

FIG. 26 illustrates a schematic block diagram of an apparatus 2600 in a wireless network (for example, the wireless network shown in FIG. 12). The apparatus may be implemented in a wireless device or network node (e.g., wireless device 1210 or network node 1260 shown in FIG. 12). Apparatus 2600 is operable to carry out the example method described with reference to FIG. 25 and possibly any other processes or methods disclosed herein. It is also to be understood that the method of FIG. 25 is not necessarily carried out solely by apparatus 2600. At least some operations of the method can be performed by one or more other entities.

Virtual Apparatus 2600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2502 and any other suitable units of apparatus 2600 to perform corresponding functions according one or more embodiments of the present disclosure.

As illustrated in FIG. 26, apparatus 2600 includes receiving unit 2602, which is configured to receive a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.

FIG. 270 illustrates a Method in accordance with some embodiments

FIG. 270 depicts a method performed by a wireless device in accordance with particular embodiments. In step 2702, the wireless device receives information from a base station, said information indicating whether the wireless device should use a normal uplink, NUL, or a supplementary uplink, SUL, for transmission of a Sounding Reference Signal for positioning.

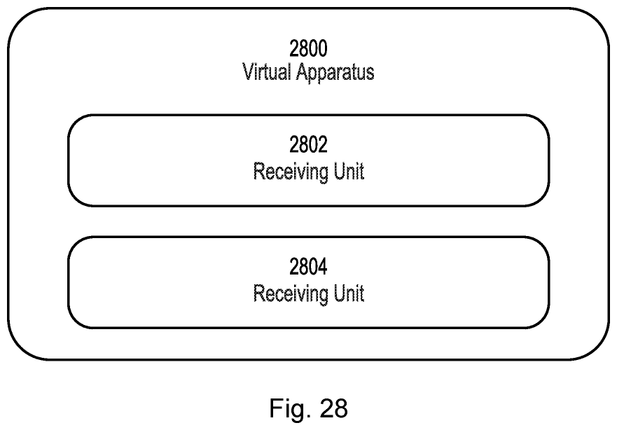

FIG. 28: Virtualization apparatus in accordance with some embodiments

FIG. 28 illustrates a schematic block diagram of an apparatus 2800 in a wireless network (for example, the wireless network shown in FIG. 12). The apparatus may be implemented in a wireless device or network node (e.g., wireless device 1210 or network node 1260 shown in FIG. 12). Apparatus 2800 is operable to carry out the example method described with reference to Figure VV4 and possibly any other processes or methods disclosed herein. It is also to be understood that the method of Figure VV4 is not necessarily carried out solely by apparatus 2800. At least some operations of the method can be performed by one or more other entities.

Virtual Apparatus 2800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiver unit 2802 and second receiver unit 2804, and any other suitable units of apparatus 2800 to perform corresponding functions according one or more embodiments of the present disclosure.

As illustrated in FIG. 28, apparatus 2800 includes first receiver unit 2802 for receiving information from a base station, said information indicating whether the wireless device should use a normal uplink, NUL, or a supplementary uplink, SUL, for transmission of a Sounding Reference Signal for positioning.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EMBODIMENTS

### Group A Embodiments

1. A method performed by a wireless device, the method comprising:
   receiving a Medium Access Control, MAC, Control Element, CE, wherein the MAC CE comprises information indicating whether a Sounding Reference Signal, SRS, for spatial relation is available.
2. A method according to embodiment 1, wherein the MAC CE comprises a first bit, wherein a first value of the first bit indicates that SRS for spatial relation is available, and wherein a second value of the first bit indicates that SRS for spatial relation is not available.
3. A method according to embodiment 1, wherein the MAC CE also comprises information indicating whether the SRS for spatial relation is valid for multiple resources.
4. A method according to embodiment 3, wherein the MAC CE comprises first and second bits, wherein a first value of the first and second bits indicates that SRS for spatial relation is not available, wherein a second value of the first and second bits indicates that SRS for spatial relation is available and valid for a specific BWP, and wherein a third value of the first and second bits indicates that SRS for spatial relation is available valid for multiple resources.
5. A method according to embodiment 4, where said multiple resources comprise all bandwidth parts, BWP.
6. A method performed by a wireless device, the method comprising:
   receiving a Medium Access Control, MAC, Control Element, CE, wherein the MAC CE comprises information indicating whether a Sounding Reference Signal, SRS, for spatial relation is valid for multiple resources.
7. A method according to embodiment 6, wherein said multiple resources comprise all bandwidth parts, BWP.
8. A method according to embodiment 6 or 7, wherein said multiple resources comprise all cells that the wireless device is configured with.
9. A method according to embodiment 6, wherein the MAC CE comprises a first bit, wherein a first value of the first bit indicates that SRS for spatial relation is valid for a specific BWP, and wherein a second value of the first bit indicates that SRS for spatial relation is valid for all BWP.
10. A method according to embodiment 6, wherein the MAC CE comprises a second bit, wherein a first value of the second bit indicates that SRS for spatial relation is valid for a specific cell, and wherein a second value of the second bit indicates that SRS for spatial relation is valid for all serving cells of the wireless device.
11. A method according to embodiment 6, wherein the information indicating whether a Sounding

Reference Signal, SRS, for spatial relation is valid for multiple resources comprises an identity of a serving cell of the wireless device, and wherein a presence or absence of said serving cell on a configured list of cells indicates whether SRS for spatial relation is valid for all cells that the wireless device is configured with.
12. A method according to embodiment 6, wherein the MAC CE also comprises information indicating whether the SRS for spatial relation is available.
13. A method according to embodiment 12, wherein the MAC CE comprises first and second bits, wherein a first value of the first and second bits indicates that SRS for spatial relation is not available, wherein a second value of the first and second bits indicates that SRS for spatial relation is available and valid for a specific BWP, and wherein a third value of the first and second bits indicates that SRS for spatial relation is available valid for multiple resources.
14. A method according to embodiment 13, where said multiple resources comprise all bandwidth parts, BWP.
15. A method performed by a wireless device, the method comprising:
   receiving a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.
16. A method according to embodiment 15, wherein said information identifying whether a DL-PRS identifier is present is included in the information identifying a spatial relation for a resource identifier with DL-PRS.
17. A method according to embodiment 15 or 16, wherein the MAC CE comprises a first bit, wherein a first value of the first bit indicates that the DL-PRS identifier is present, and wherein a second value of the first bit indicates that the DL-PRS identifier is absent.
18. A method performed by a wireless device, the method comprising: receiving information from a base station, said information indicating whether the wireless device should use a normal uplink, NUL, or a supplementary uplink, SUL, for transmission of a Sounding Reference Signal, SRS.
19. A method according to embodiment 18, comprising transmitting the SRS on the NUL or on the SUL, in accordance with said received information.
20. The method of any of the previous embodiments, further comprising:
   providing user data; and
   forwarding the user data to a host computer via the transmission to the base station.

### Group B Embodiments

21. A method performed by a base station for configuring a wireless device, the method comprising:
   transmitting a Medium Access Control, MAC, Control Element, CE, wherein the MAC CE comprises information indicating whether a Sounding Reference Signal, SRS, for spatial relation is available.
22. A method according to embodiment 21, wherein the MAC CE comprises a first bit, wherein a first value of the first bit indicates that SRS for spatial relation is available, and wherein a second value of the first bit indicates that SRS for spatial relation is not available.
23. A method according to embodiment 21, wherein the MAC CE also comprises information indicating whether the SRS for spatial relation is valid for multiple resources.
24. A method according to embodiment 23, wherein the MAC CE comprises first and second bits, wherein a first value of the first and second bits indicates that SRS for spatial relation is not available, wherein a second value of the first and second bits indicates that SRS for spatial relation is available and valid for a specific BWP, and wherein a third value of the first and second bits indicates that SRS for spatial relation is available valid for multiple resources.
25. A method according to embodiment 24, where said multiple resources comprise all bandwidth parts, BWP.
26. A method performed by a base station for configuring a wireless device, the method comprising:
   transmitting a Medium Access Control, MAC, Control Element, CE, wherein the MAC CE comprises information indicating whether a Sounding Reference Signal, SRS, for spatial relation is valid for multiple resources.
27. A method according to embodiment 26, wherein said multiple resources comprise all bandwidth parts, BWP.
28. A method according to embodiment 26 or 27, wherein said multiple resources comprise all cells that the wireless device is configured with.
29. A method according to embodiment 26, wherein the MAC CE comprises a first bit, wherein a first value of the first bit indicates that SRS for spatial relation is valid for a specific BWP, and wherein a second value of the first bit indicates that SRS for spatial relation is valid for all BWP.
30. A method according to embodiment 26, wherein the MAC CE comprises a second bit, wherein a first value of the second bit indicates that SRS for spatial relation is valid for a specific cell, and wherein a second value of the second bit indicates that SRS for spatial relation is valid for all serving cells of the wireless device.
31. A method according to embodiment 26, wherein the information indicating whether a

Sounding Reference Signal, SRS, for spatial relation is valid for multiple resources comprises an identity of a serving cell of the wireless device, and wherein a presence or absence of said serving cell on a configured list of cells indicates whether SRS for spatial relation is valid for all cells that the wireless device is configured with.
32. A method according to embodiment 26, wherein the MAC CE also comprises information indicating whether the SRS for spatial relation is available.
33. A method according to embodiment 32, wherein the MAC CE comprises first and second bits, wherein a first value of the first and second bits indicates that SRS for spatial relation is not available, wherein a second value of the first and second bits indicates that SRS for spatial relation is available and valid for a specific BWP, and wherein a third value of the first and second bits indicates that SRS for spatial relation is available valid for multiple resources.
34. A method according to embodiment 33, where said multiple resources comprise all bandwidth parts, BWP.
35. A method performed by a base station for configuring a wireless device, the method comprising:
   transmitting a Medium Access Control, MAC, Control Element, CE, wherein the MAC CE comprises information identifying a spatial relation for a resource identifier with downlink positioning reference signal, DL-PRS, and wherein the MAC CE comprises information identifying whether a DL-PRS identifier is present.
36. A method according to embodiment 35, wherein said information identifying whether a DL-PRS identifier is present is included in the information identifying a spatial relation for a resource identifier with DL-PRS.
37. A method according to embodiment 35 or 36, wherein the MAC CE comprises a first bit, wherein a first value of the first bit indicates that the DL-PRS identifier is present, and wherein a second value of the first bit indicates that the DL-PRS identifier is absent.
38. A method performed by a network node, the method comprising determining whether a normal uplink, NUL, or a supplementary uplink, SUL, should be used for transmission of a Sounding Reference Signal, SRS, for positioning by a wireless device.
39. A method according to embodiment 38, wherein the network node is a base station.
40. A method according to embodiment 39, wherein the network node is a gNB.
41. A method according to embodiment 39 or 40, further comprising:
   notifying a Location Management Function, LMF, of the network of the determination whether a NUL or a SUL should be used for transmission of the SRS for positioning.
42. A method according to embodiment 41, further comprising notifying the LMF of the determination whether the NUL or the SUL should be used for transmission of the SRS for positioning in a New Radio Positioning Protocol A (NRPPa) protocol message.
43. A method according to embodiment 38, wherein the network node is Location Management Function, LMF, of the network.
44. A method according to embodiment 43, comprising notifying at least one other network node of the determination whether the NUL or the SUL should be used for transmission of the SRS for positioning.
45. A method according to embodiment 44, comprising notifying a serving base station of the wireless device whether the NUL or the SUL should be used by the wireless device for transmission of the SRS for positioning.
46. A method according to one of embodiments 38 to 42, comprising determining whether the NUL or the SUL should be used for transmission of the SRS for positioning. based on measurements associated with the wireless device.
47. A method performed by a first network node, the method comprising receiving a message from a second network node, said message indicating a result of determining whether a normal uplink, NUL, or a supplementary uplink, SUL, should be used for transmission of a Sounding Reference Signal, SRS, for positioning by a wireless device.
48. A message according to embodiment 47, further comprising providing information to at least one additional network node of said result.
49. A method according to embodiment 47 or 48, wherein the first network node is a Location Management Function, LMF, of the network, and the second network node is a serving base station of the wireless device.
50. A method according to embodiment 49, comprising receiving said message from the second network node in a New Radio Positioning Protocol A (NRPPa) protocol message.
51. The method of any of the previous Group B embodiments, further comprising:
   obtaining user data; and
   forwarding the user data to a host computer or a wireless device.

### Group C Embodiments

52. A wireless device comprising:
   processing circuitry configured to perform any of the steps of any of the Group A embodiments; and
   power supply circuitry configured to supply power to the wireless device.
53. A base station comprising:
   processing circuitry configured to perform any of the steps of any of the Group B embodiments;
   power supply circuitry configured to supply power to the base station.
      54. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
      55. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
      56. The communication system of the previous embodiment further including the base station.
      57. The communication system of the previous 2 embodiments, further including the UE, wherein the UE is configured to communicate with the base station.
      58. The communication system of the previous 3 embodiments, wherein:
   the processing circuitry of the host computer is configured to execute a host application, thereby providing the user data; and
   the UE comprises processing circuitry configured to execute a client application associated with the host application.
      59. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
      60. The method of the previous embodiment, further comprising, at the base station, transmitting the user data.
      61. The method of the previous 2 embodiments, wherein the user data is provided at the host computer by executing a host application, the method further comprising, at the UE, executing a client application associated with the host application.
      62. A user equipment (UE) configured to communicate with a base station, the UE comprising a radio interface and processing circuitry configured to performs the of the previous 3 embodiments.
      63. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
      64. The communication system of the previous embodiment, wherein the cellular network further includes a base station configured to communicate with the UE.
      65. The communication system of the previous 2 embodiments, wherein:
   the processing circuitry of the host computer is configured to execute a host application, thereby providing the user data; and
   the UE's processing circuitry is configured to execute a client application associated with the host application.
      66. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
      67. The method of the previous embodiment, further comprising at the UE, receiving the user data from the base station.
      68. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
      69. The communication system of the previous embodiment, further including the UE.
      70. The communication system of the previous 2 embodiments, further including the base station, wherein the base station comprises a radio interface configured to communicate with the UE and a communication interface configured to forward to the host computer the user data carried by a transmission from the UE to the base station.
      71. The communication system of the previous 3 embodiments, wherein:
   the processing circuitry of the host computer is configured to execute a host application; and
   the UE's processing circuitry is configured to execute a client application associated with the host application, thereby providing the user data.
      72. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
      73. A method implemented in a communication system including a host computer, a base station and a user equipment (UE), the method comprising:
   at the host computer, receiving user data transmitted to the base station from the UE, wherein the UE performs any of the steps of any of the Group A embodiments.
      74. The method of the previous embodiment, further comprising, at the UE, providing the user data to the base station.
      75. The method of the previous 2 embodiments, further comprising:
   at the UE, executing a client application, thereby providing the user data to be transmitted; and
   at the host computer, executing a host application associated with the client application.
      76. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
      77. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
      78. The communication system of the previous embodiment further including the base station.
      79. The communication system of the previous 2 embodiments, further including the UE, wherein the UE is configured to communicate with the base station.
      80. The communication system of the previous 3 embodiments, wherein:
   the processing circuitry of the host computer is configured to execute a host application;
   the UE is configured to execute a client application associated with the host application, thereby providing the user data to be received by the host computer.
      81. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
      82. The method of the previous embodiment, further comprising at the base station, receiving the user data from the UE.
      83. The method of the previous 2 embodiments, further comprising at the base station, initiating a transmission of the received user data to the host computer.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1× RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-24. (canceled)

25. A method performed by a wireless device, the method comprising:
receiving a Medium Access Control (MAC) Control Element (CE), wherein the MAC CE comprises information indicating whether a Sounding Reference Signal (SRS) for spatial relation is available.

26. The method according to claim 25, wherein the MAC CE comprises a first bit, wherein a first value of the first bit indicates that the SRS for spatial relation is available, and wherein a second value of the first bit indicates that the SRS for spatial relation is not available.

27. The method according to claim 25, wherein the MAC CE also comprises information indicating whether the SRS for spatial relation is valid for multiple resources.

28. The method according to claim 25, wherein the MAC CE comprises first and second bits, wherein a first value of the first and second bits indicates that the SRS for spatial relation is not available, wherein a second value of the first and second bits indicates that the SRS for spatial relation is available and valid for a specific bandwidth part (BWP), and wherein a third value of the first and second bits indicates that the SRS for spatial relation is available and valid for multiple resources.

29. The method according to claim 28, wherein the multiple resources comprise all BWPs.

30. A method performed by a wireless device, the method comprising:
receiving a Medium Access Control (MAC) Control Element (CE), wherein the MAC CE comprises information identifying a spatial relation for a resource identifier with downlink positioning reference signal (DL-PRS), and wherein the MAC CE comprises information identifying whether a DL-PRS identifier is present.

31. The method according to claim 30, wherein said information identifying whether a DL-PRS identifier is present is included in the information identifying a spatial relation for a resource identifier with DL-PRS.

32. The method according to claim 30, wherein the MAC CE comprises a first bit, wherein a first value of the first bit indicates that the DL-PRS identifier is present, and wherein a second value of the first bit indicates that the DL-PRS identifier is absent.

33. A method performed by a base station for configuring a wireless device, the method comprising:
transmitting a Medium Access Control (MAC) Control Element (CE), wherein the MAC CE comprises information indicating whether a Sounding Reference Signal (SRS) for spatial relation is available.

34. The method according to claim 33, wherein the MAC CE comprises a first bit, wherein a first value of the first bit indicates that the SRS for spatial relation is available, and wherein a second value of the first bit indicates that the SRS for spatial relation is not available.

35. The method according to claim 33, wherein the MAC CE also comprises information indicating whether the SRS for spatial relation is valid for multiple resources.

36. The method according to claim 33, wherein the MAC CE comprises first and second bits, wherein a first value of the first and second bits indicates that the SRS for spatial relation is not available, wherein a second value of the first and second bits indicates that the SRS for spatial relation is available and valid for a specific bandwidth part (BWP), and wherein a third value of the first and second bits indicates that the SRS for spatial relation is available and valid for multiple resources.

37. The method according to claim 36, wherein the multiple resources comprise all BWPs.

38. A method performed by a base station for configuring a wireless device, the method comprising:
transmitting a Medium Access Control (MAC) Control Element (CE), wherein the MAC CE comprises information identifying a spatial relation for a resource identifier with downlink positioning reference signal (DL-PRS), and wherein the MAC CE comprises information identifying whether a DL-PRS identifier is present.

39. The method according to claim 38, wherein said information identifying whether the DL-PRS identifier is present is included in the information identifying a spatial relation for the resource identifier with DL-PRS.

40. The method according to claim 38, wherein the MAC CE comprises a first bit, wherein a first value of the first bit indicates that the DL-PRS identifier is present, and wherein a second value of the first bit indicates that the DL-PRS identifier is absent.

41. A wireless device comprising processing circuitry, wherein the processing circuitry is configured to cause the wireless device to:
receive a Medium Access Control (MAC) Control Element (CE), wherein the MAC CE comprises information indicating whether a Sounding Reference Signal (SRS) for spatial relation is available.

42. A wireless device comprising processing circuitry, wherein the processing circuitry is configured to cause the wireless device to:
receive a Medium Access Control (MAC) Control Element (CE), wherein the MAC CE comprises information identifying a spatial relation for a resource identifier with downlink positioning reference signal (DL-PRS), and wherein the MAC CE comprises information identifying whether a DL-PRS identifier is present.
